(19) United States
(12) Patent Application Publication
(10) Pub. No.: US 2024/0189755 A1
(43) Pub. Date: Jun. 13, 2024

(54) LOW-PRESSURE DROP STRUCTURE OF PARTICLE ADSORBENT BED FOR IMPROVED ADSORPTION GAS SEPARATION PROCESS

(71) Applicant: W. L. Gore & Associates, Inc., Newark, DE (US)

(72) Inventors: Edward H. Cully, Clarksville, VA (US); Christine M. Scotti, Newark, DE (US)

(21) Appl. No.: 18/537,129

(22) Filed: Dec. 12, 2023

Related U.S. Application Data
(60) Provisional application No. 63/432,299, filed on Dec. 13, 2022.

(51) Int. Cl. B01D 53/04

(52) U.S. Cl. CPC B01D 53/0446; B01D 53/0438; B01D 2253/304; B01D 2253/311; B01D 2257/504; B01D 2259/40084

(57) ABSTRACT

A gas separation unit is disclosed for the separation of a first gas from a mixture containing said first gas as well as further gases by a cyclic adsorption/desorption process using a loose particulate sorbent material for gas adsorption. The plurality of particulate active material constructs are arranged in at least two stacked layers that are mounted on a stiff rectangular circumferential frame. Each layer of the particulate active material construct includes two sheets of a flexible fabric material which is hydrophobic and gas permeable but impermeable to a loose particulate active material for gas adsorption. A plurality of tubes is provided for a heat exchange fluid within the frame. The frame structure is provided with a plurality of holes through which the plurality of tubes penetrate.

### CROSS-REFERENCE TO RELATED APPLICATION

This application claims the benefit of U.S. Provisional Application No. 63/432,299, filed Dec. 13, 2022, the disclosure of which is incorporated herein by reference in its entirety for all purposes.

### FIELD

The present disclosure relates to sorbent bed structures for gas separation processes and the use of such structures for gas separation, for example for the separation/capture of CO₂ from gas streams.

### BACKGROUND

Gas separation by adsorption has many different applications in industry, for example removing a specific component from a gas stream, where the desired product can either be the component removed from the stream, the remaining depleted stream, or both. Thereby both, trace components as well as major components of the gas stream can be targeted by the adsorption process.

One important application is capturing carbon dioxide (CO₂) from gas streams, e.g., from flue gases, exhaust gases, industrial waste gases, biogas or atmospheric air.

Capturing CO₂ directly from the atmosphere, referred to as direct air capture (DAC), is one of several means of mitigating anthropogenic greenhouse gas emissions and has attractive economic perspectives as a non-fossil, location-independent CO₂ source for the commodity market and for the production of synthetic fuels. The specific advantages of CO₂ capture from the atmosphere include: (i) DAC can address the emissions of distributed sources (e.g. cars, planes), which account for a large portion of the worldwide greenhouse gas emissions and can currently not be captured at the site of emission in an economically feasible way; (ii) DAC can address emissions from the past and can therefore create truly negative emissions; (iii) DAC systems do not need to be attached to the source of emission but are rather location independent and can for example be located at the site of further CO₂ processing; and (iv) if CO₂ that was captured from the atmosphere is used for the production of synthetic hydrocarbon fuels from renewable energy sources, truly non-fossil fuels for the transportation sector can be obtained, that create no or very few net CO₂ emissions to the atmosphere.

Several DAC methods have recently been developed based on various technological approaches. For example, U.S. Pat. No. 8,163,066 B2 (Eisenberger) discloses carbon dioxide capture/regeneration structures and techniques; US 2009/0120288 A1 (Lackner et al.) discloses a method for removal of carbon dioxide from air; US 2012/0174778 A1 (Eisenberger) discloses a carbon dioxide capture/regeneration method using a vertical elevator; and WO 2010/022339 A2 (Alberta Ltd.) discloses a carbon dioxide capture method and facility.

One particular approach is based on a cyclic adsorption/desorption process on solid, chemically functionalized sorbent materials. For example, in WO 2010/091831 A1 (Eth Zurich) a structure based on amine functionalized solid sorbent materials together with a cyclic adsorption/desorption process using this material for the extraction of carbon dioxide from ambient air is disclosed. Therein, the adsorption process takes place at ambient conditions at which air is streamed through the sorbent material and a portion of the CO₂ contained in the air is chemically bound at the amine functionalized surface of the sorbent. During the subsequent desorption, the material is heated to about 50-110° C. and the partial pressure of carbon dioxide surrounding the sorbent is reduced by applying a vacuum or exposing the sorbent to a purge gas flow. Thereby, the previously captured carbon dioxide is removed from the sorbent material and obtained in a concentrated form.

In WO 2012/168346 A1 (Empa Eidgenössische Materialprüfungs-Und Forschungsanstalt), a sorbent material based on amine functionalized cellulose is disclosed, which can be used for the above described process.

Generally, for adsorption-based gas separation processes, configurations of the sorbent material are desired which impose little pressure drop on the gas flow in order to minimize the energy required for gas pumping and at the same time achieve maximum contact between the sorbent and the gas stream in order to maximize the mass transfer rates of the components to be removed from the gas stream. Typical configurations include packed bed columns or fluidized beds with typical lengths of several ten centimeters to several meters, which typically impose pressure drops of several thousand Pascal up to several bars on the gas flow. Such a structure is e.g. disclosed in WO 2014/170184 A1 (Climeworks AG).

The requirement on the pressure drop can become even more severe, if trace components are removed from a gas stream. In particular, all DAC approaches have one major challenge in common which are the very large air volumes that have to be passed through any capture system in order to extract a certain amount of CO₂ from the air. The reason for this is the very low concentration of CO₂ in the atmospheric air, currently between 390 and 400 ppm, i.e., roughly 0.04%. Thus, in order to extract one metric ton of CO₂ from the atmosphere, at least about 1,400,000 cubic meters of air have to be passed through the capture system. This in turn means that economically feasible capture systems must have a very low pressure drop on the air flow passing through them. Otherwise the energy requirements for air pumping will render the system uneconomical. However, any low-pressure drop configuration should not compromise the mass transfer properties of the system.

While many materials that have promising properties for a DAC process are typically in a granular form, their arrangement in a conventional packed bed column or in a fluidized bed with a length of typically several ten centimeters to several meters will usually not be feasible, since the resulting pressure drops will exceed the tolerable limits by one or several orders of magnitude.

On the other hand, in the field of particle filters for gas streams, in particular soot particle filters for exhaust gases, channeled filter structures were developed, typically referred to as “wall flow” filters, see for example EP 0766993 A2 (Toyota Jidosha Kabushiki Kaisha). In these structures the gas flow enters the structure through inlet channels, passes porous walls, at which the soot particles are trapped, and exits the structure through outlet channels.

Monolithic structures comprising sorbent materials were also developed in the context of gas separation and adsorption, e.g. WO 2010/027929 A1 (Alstom Technology Ltd), U.S. Pat. No. 8,202,350 B2 (SRI International).

### SUMMARY

An object of U.S. Pat. No. 11,007,470 B2 assigned to Climeworks AG (hereinafter “the '470 Climeworks publication”) is to provide an improved gas separation unit for the separation of at least a first gas from a mixture containing said first gas as well as further gases different from the first gas by using a cyclic adsorption/desorption process using a loose particulate sorbent material for gas adsorption. Typically the loose particulate sorbent material for gas adsorption is a particulate material which at least at its surface is amine-functionalized, e.g. weak base ion exchange resins, for capture of the first gas, in particular in case the first gas is carbon dioxide. Examples of such materials are e.g. disclosed in WO 2010/091831 A1 or WO 2016/005226 A1 (Climeworks AG). The loose particular sorbent material can be e.g. an amine-modified particular material, preferably based on a weak base ion exchange resin, specifically polystyrene matrix material modified with amine groups, specially primary amine groups, or based on cellulose, more preferably based one amine-modified nanofibrilated cellulose, in each case preferably with an average particle diameter in the range of 60 to 1200 μm, for the adsorption of carbon dioxide. It can however also be another material in particulate form, which is able to adsorb CO₂ upon passage of a gas stream through the material and able to release the CO₂ again if corresponding different conditions (mainly change in at least one of pressure, temperature, humidity) are chosen. In accordance with the disclosure of the '470 Climeworks publication, said particulate sorbent material is arranged in at least two stacked layers (forming a stack, typically of a plurality of such layers, normally at least 4, preferably at least 10, particularly preferably in the range of 25-40 or 25-60 layers are arranged in such a stack), wherein each layer comprises two sheets of a flexible fabric material which is gas permeable but impermeable to the loose particulate sorbent material, and which sheets are arranged essentially parallel defining an inlet face of the layer and an outlet face of the layer.

In the present disclosure, the particulate sorbent material (as disclosed above in the '470 Climeworks publication) can be considered an “active material” which can actively perform the adsorbing and desorbing processes as disclosed herein. In some examples, alternatively, the active material can be an inactive particulate base material (which cannot perform the adsorbing and desorbing processes on its own) which is coated with an active material, such as a soluble sorbent material, thereby forming an active adsorbent particulate based on an inactive particulate base material. Therefore, the active material may be an active sorbent particulate material or an inactive particulate base material coated with the soluble sorbent material as disclosed herein. In some examples, the active material may include, but is not limited to, an ion exchange resin (e.g., a strongly basic anion exchange resin such as Dowex™ Marathon™, a resin available from Dow Chemical Company), zeolite, activated carbon, alumina, metal-organic frameworks, polyethylenimine (PEI), or another suitable CO₂-adsorbing material, such as desiccant, carbon molecular sieve, carbon adsorbent, graphite, activated alumina, molecular sieve, aluminophosphate, silicoaluminophosphate, zeolite adsorbent, ion exchanged zeolite, hydrophilic zeolite, hydrophobic zeolite, modified zeolite, natural zeolites, faujasite, clinoptilolite, mordenite, metal-exchanged silico-aluminophosphate, uni-polar resin, bi-polar resin, aromatic cross-linked polystyrenic matrix, brominated aromatic matrix, methacrylic ester copolymer, graphitic adsorbent, carbon fiber, carbon nanotube, nano-materials, metal salt adsorbent, perchlorate, oxalate, alkaline earth metal particle, microporous titanosilicates such as Engelhard titanosilicate (ETS) and/or coralloid titanosilicate (CTS), metal oxide, chemisorbent, amine, organo-metallic reactant, hydrotalcite, silicalite, zeolitic imadazolate framework and metal organic framework (MOF) adsorbent compounds, and/or any suitable combinations thereof.

When talking about stacked layers or a stack in the '470 Climeworks publication, this shall not imply that the individual layers are necessarily on top of one-another and/or contacting each other. The layers in such a stack are arranged adjacent (but with a distance between) and neighboring, and their main planes are arranged parallel, essentially parallel or with a defined inclination angle of not more than 10° (angle between plane normals).

The orientation of such a stack of the '470 Climeworks publication can be such that the planes of the individual layers are essentially horizontal planes. Between the layers there are therefore in this case horizontal slots for the entry of the inflow of the gas mixture and horizontal slots for the outflow of the gas depleted in CO₂. Such a substantially horizontal stack configuration can be selected to avoid the formation of holes in the layers due to the motion of the sorbent material during operation. Such holes can lead to bypassing of a large portion of the main airflow as they can form a significantly lower pressure drop region.

In some cases according to the '470 Climeworks publication however it has been observed that also in such a substantially horizontal configuration, hole formation can occur and a more controlled formation of holes can be realized in a vertical orientation of the stack and/or with a better homogeneity and stability of the layer surface

According to another embodiment in the '470 Climeworks publication therefore the layers can be placed vertically—the complete stack is so to speak rotated 90° around the main horizontal axis of the whole unit. In other words in this orientation between the layers there are vertical slots for the entry of the inflow of the gas mixture and vertical slots for the outflow of the gas depleted in CO₂. In this manner any relocation/motion of sorbent nevertheless leads to a homogenous bed due to the weight of the sorbent material and the corresponding downward motion of the particles which closes any formed holes in a self-ordering process. In order to avoid that formed holes at the upper edge of the layer lead to bypassing, a slat made preferably of aluminum can be affixed at the upper edge being oriented along the upper edge of the layer on the inflow and outflow face of the layer, in contact with the outer surface of the layer, covering and thereby blocking a portion of the layer—and any potentially formed holes—to inflow and thusly forcing all inflow through the sorbent material layer containing sufficient sorbent particles in this region. The width of the slat can be in the range of 1-25 cm or 1-15 cm, preferably 2-15 cm or 2-10 cm.

Also intermediate rotated stack orientations are possible according to the '470 Climeworks publication, where the plane normals are oriented in a plane perpendicular to the inflow direction, e.g. orientations where the slots for the entry of the inflow of the gas mixture and slots for the outflow of the gas depleted in CO₂ are between the horizontal or the vertical direction, e.g. at 45°.

Further the flexible fabric material layers of the '470 Climeworks publication are arranged with a distance in the range of 0.3-5.0 cm or in the range of 0.5-2.5 cm, and are enclosing a cavity in which the particulate sorbent material is located. The type of the flexible fabric material is chosen to be sufficiently gas/air permeable to allow optimum flow through of the gas or generally speaking the gas mixture (e.g. air), and are sufficiently tight so as to avoid that the particulate sorbent material can penetrate through these layers.

In the present disclosure, flexible fabric material layers as disclosed herein are arranged with a distance (defining a thickness “T”) inclusively within the range of 1-5 mm (e.g., inclusively within the range of 1-2 mm, inclusively within the range of 1-2.5 mm, inclusively within the range of 1-3 mm, inclusively within the range of 1-4 mm, or any other suitable value or range therebetween, or combination thereof) and are enclosing a cavity in which the particulate active material is located. The type of the flexible fabric material may be chosen or selected based on one or more of the following characteristics: 1) the flexible fabric material may be sufficiently hydrophobic to allow water vapor to enter but prohibit liquid water from entering, 2) the flexible fabric material may be sufficiently gas/air permeable to allow optimum flow through of the gas or generally speaking the gas mixture (e.g. air), and/or 3) porosity or “pores” of the flexible fabric material may be sufficiently tight so as to avoid the particulate active material from penetrating through these layers and escaping. The flexible fabric material may be provided as a laminate, in multiple layers with differing characteristics if desired, for instance, one layer may provide hydrophobicity while another layer provides durability.

The layers of flexible fabric material of the '470 Climeworks publication are further mounted on a stiff rectangular circumferential frame structure, typically being fixed at opposite sides thereof.

Said stiff rectangular circumferential frame structure of the '470 Climeworks publication is formed by four metal profiles arranged pairwise mutually parallel, said metal profiles having pairs of legs arranged essentially parallel to said inlet face of the layer and said outlet face of the layer, respectively, and allowing for fixing said sheets circumferentially to said legs on each respective face.

Further, according to a preferred embodiment of the '470 Climeworks publication, a plurality of meandering tubes for a heat exchange fluid can be provided within said stiff rectangular circumferential frame structure and within said cavity, wherein the plurality of tubes over the non-bent portions thereof are all being arranged essentially parallel to one first pair of said mutually parallel metal profiles.

Said tubes of the '470 Climeworks publication are in thermal contact with a plurality of sheets of metal which are arranged parallel to each other and which are arranged essentially perpendicular to a main plane of the frame and perpendicular to said tubes (to the non-bent portions thereof), the tubes extend in a continuous manner between said first pair of mutually parallel metal profiles and are provided with a plurality of holes through which the plurality of tubes penetrate. The tubes of the primary heat exchange element are preferably metal tubes, preferably aluminum or copper tubes. These tubes can be provided with an inner diameter in the range of 3-20 mm, preferably in the range of 5-12 mm, and/or with an outer diameter in the range of 4-24 mm, preferably in the range of 6.2-14 mm.

The tubes of the primary heat exchange element of the '470 Climeworks publication are typically, where running parallel, spaced by a distance (x) in the range of 10-168 mm, preferably in the range of 15.5-98 mm.

The sheets of metal if forming the secondary heat exchange elements according to a preferred embodiment of the '470 Climeworks publication have a thickness in the range of 0.1-0.4 mm, preferably in the range of 0.12-0.18 mm.

The sheets of metal if forming the secondary heat exchange elements according to another preferred embodiment of the '470 Climeworks publication have a height (h), measured perpendicular to the running direction of the tubes in the range of 3-50 mm, preferably in the range of 8-22 mm.

The sheets of metal if forming the secondary heat exchange elements according to a preferred embodiment of the '470 Climeworks publication have a length being less than 20 mm, preferably less than 5 mm shorter than the distance between the respective pair of metal profiles arranged pairwise mutually parallel forming said stiff rectangular circumferential frame structure.

Preferably the sheets of metal of the '470 Climeworks publication are made of aluminum.

Typically, the sheets of metal of the '470 Climeworks publication if forming the secondary heat exchange elements are spaced by a distance (d) in the range of 1-6 mm, preferably in the range of 3.5-5.5 mm.

As concerns the dimensioning of the tubes and the metal sheets of the '470 Climeworks publication, the above mentioned values are an optimum compromise allowing for good interpenetration by the particulate sorbent material, also allowing filling of the structure in the manufacturing process, and on the other hand allowing for sufficient porosity for the air passing through the layer, and allowing for an efficient as possible heat transfer process for the heating and cooling steps in the cyclic temperature swing carbon dioxide capture process.

The tubing forming the primary heat exchange pipes of the '470 Climeworks publication can also have, at least in sections, a non-circular cross-section (flattened shape). Quite specifically, the first outer diameter of the cross section of the pipes in a direction perpendicular to the plane of the layer of the stiff frame structure can be at least twice as large as the second outer diameter of the cross section of the pipes in the longitudinal direction. By providing piping which is “slim” in the plane of the layer of the stiff frame structure the pipes appearing like upright partitioning walls in the cavity, an essentially planar surface is provided at the face of adjacent pipes, allowing for most efficient attachment of and heat exchange with secondary heat exchange elements in the form of heat exchange metal sheets and/or the sorbent as will be detailed as follows.

This design of the flattened pipes of the '470 Climeworks publication results in two substantial advantages over heat exchange pipes with a circular cross section: First, the area that is available for gas flow through the planes of the sheets of flexible fabric material is much larger since a smaller portion of this flow cross-section area is blocked by the pipes. This results in reduced pressure drop on the gas flow. Second, the pipes can be spaced closer to each other compared to prior art designs with circular pipe cross sections while the area available for gas flow still remains larger compared to those prior art designs. This results in an optimized heat transfer design since the distances for heat transfer through the sorbent material between the flattened pipes is reduced.

Said flattened pipes of the '470 Climeworks publication can further be in thermal contact with sheets of metal forming the secondary heat exchange element and which are arranged essentially perpendicular to the main plane of the stiff frame structure, and which extend oscillating between pairwise adjacent flattened pipes, thereby contacting them for thermal contact. In other words these metal sheets are either wavy oscillating between adjacent flattened pipes and contacting the flat small-diameter surfaces, or zigzagging between adjacent flattened pipes and contacting the flat small-diameter surfaces.

As an alternative to the sheets of metal or in addition to these said flattened pipes of the '470 Climeworks publication can be held in place with spacers which are arranged essentially perpendicular to the main plane of the frame, and which at least extend between pairwise adjacent flattened pipes.

The unit of the '470 Climeworks publication has a gas inlet side or gas inlet manifold through which an inflow of gas mixture enters the unit and a gas outlet side or gas outlet manifold through which a gas outflow exits the unit, the gas pathway between the inflow and the outflow being confined in the unit to pass through at least one layer.

In order to avoid the accumulation of solid particulate pollutants contained in the inflow within the sorbent material layers-leading to a degradation in performance—at least one further layer of filter fabric material of the '470 Climeworks publication can be mounted upstream of the stacked sorbent material layers, such that the inflow must pass through said filter fabric material. Also the flexible fabric material layers or at least the upstream flexible fabric material layer can be selected to have the filter effect. The use of such a filter material, which will be further detailed below, in a carbon dioxide capture unit is as such and independent of the frame structure.

The layers of the '470 Climeworks publication are arranged in the unit such that the inflow passes through the inlet face, subsequently through the particulate sorbent material located in the cavity of the respective layer, subsequently to exit the respective layer through the outlet face to form the gas outflow, and the layers are arranged such that inlet faces of adjacent layer are facing each other enclosing gas inlet channels and such that outlet faces are facing each other enclosing gas outlet channels.

The mean distance between inlet faces and/or outlet faces defining said channels of the '470 Climeworks publication, measured in a direction essentially perpendicular to a main gas inflow direction and a main gas outflow direction, respectively, is in the range of 0.5-15 cm or 0.5-13 cm, including the situation where the layers at respective adjacent edges touch each other and are inclined relative to each other, preferably all the layers forming the stack have essentially the same distance between the respective flexible fabric sheets, so all the layers have the same height. The total frame depth Dft is in the range of 0.5-1.8 m or in the range of 0.75-1.25 m or 0.9-1.1 m. The frame width is Wf in the range of 0.5-1.9 or in the range of 0.57-1.79 m with a preferred dimension of 1.19-1.58 m.

The corresponding layer structure as proposed in the '470 Climeworks publication is an optimum compromise as concerns pressure drop across the layer and/or stack, as concerns mechanical stiffness and rigidity of each layer, and as concerns thermal mass. Only if these properties are optimized, can the carbon dioxide capture process be carried out in an economical manner.

According to a first preferred embodiment of the '470 Climeworks publication on at least one, preferably on both sides of the plurality of tubes and plurality of metal sheets for thermal transfer, in particular in case of an essentially horizontal orientations of the planes of the layers of the stack, there is provided a grid structure, e.g. made of metal, such as aluminum, separating the flexible fabric material and the plurality of tubes and/or plurality of metal sheets.

The provision of such a metal grid of the '470 Climeworks publication offers protection of the flexible fabric material and improves the stability of the layer surface. Typically the flexible fabric material needs to be sufficiently fine meshed so as to avoid the particulate sorbent material to pass through. It is therefore preferably some kind of a nonwoven material, and such materials are often rather vulnerable. This vulnerability can be a problem in case the metal sheets have sharp edges, so the grid structures make sure the plurality of metal sheets cannot damage the flexible fabric layers on each side of each layer.

According to another preferred embodiment of the '470 Climeworks publication, on the side which in use is facing downwards, a further grid structure is provided forming the outermost layer and sandwiching the respective flexible fabric material layer. In other words on the downward facing side of the frame preferably a sandwich is attached, where the central flexible fabric layer is sandwiched between 2 grid structures. Like this sagging of the flexible fabric material layer can be avoided, and further protection can be provided. Due to the fact that in such a cyclic process also water and humidity can weaken and/or stretch and/or extend the flexible fabric layer, this can be an important additional aspect in order to provide for the possibility of using these units over an extended period of time.

Preferably, the grid structure of the '470 Climeworks publication is provided by a preferably woven metal, in particular aluminum wire mesh with a mesh width which is typically in the range of 0.7-20 mm×0.7-20 mm, preferably with a mesh width in the range of 1.0-2.5 mm×1.0-2.5 mm or in the range of 1.0-1.5 mm×1.0-1.5 mm.

Using aluminum inter alia has the advantage of good corrosion resistance while enabling lightweight construction according to the '470 Climeworks publication.

By providing this structure the grid structure of the '470 Climeworks publication protects the flexible fabric layer from the sharp edges of the metal sheets of the heat exchange element on both sides thereof. As concerns the bottom further grid structure being the outermost layer this is provided to avoid sagging of the lower flexible fabric layer.

According to another preferred embodiment of the '470 Climeworks publication, the flexible fabric material, and, if present, additional grid structures, is/are fixed to the frame structure by means of slats, preferably metal slats (again preferably aluminum slats). These slats are preferably extending essentially over the full-length of the respective metal profile, and the flexible fabric material layer and, if present, additional grid structure layer(s), is/are sandwiched between the respective slat and the leg of the metal profile. Further preferably the respective slat is fixed to the respective leg by at least one, preferably a row of rivet joint connections penetrating through the slat, the layers fixed there with, and the corresponding leg of the metal profile.

This attachment of the '470 Climeworks publication provides for a tight connection in particular of the flexible fabric material over the full extension of the corresponding frame element which can be handled in production efficiently and which is also of low thermal mass.

According to another preferred embodiment of the '470 Climeworks publication, the layers of the stack of at least two layers can be held in place in the housing by at least a pair of side walls which are either arranged pairwise vertically or pairwise horizontally, and on which side walls elements are provided, which allow individual layers to be shifted into the housing in a replaceable manner, wherein preferably the elements are provided as at least one of: U-shaped profiles attached to the side wall; wedges attached to the side wall; groove elements attached to the side wall cooperating with tongue elements attached to the layer, preferably to the lateral frame of the layer.

According to yet another preferred embodiment of the '470 Climeworks publication, pairs of adjacent frame structures are provided, at facing edges on one side contacting in use (meaning that layers are inclined relative to each other) with in case of one layer thereof a tongue protrusion extending over the full width of the edge, and on the other layer thereof a corresponding counter profile providing a slot also extending over the full width of the edge. Like that by inserting said tongue of one frame into said slot in the counter profile of the adjacent frame the adjacent frame elements are mechanically fixed at this contacting edge as well as sealed relative to each other.

Preferably, according the '470 Climeworks publication, said tongue protrusion is realized by means of a correspondingly structured wide slat extending over and beyond the corresponding leg of the frame profile and which is at the same time also used for fixing the flexible fabric material to said leg and, if present, additional grid structures to the leg of the corresponding metal profile.

Preferably, according the '470 Climeworks publication, said counter profile also comprises a slat which at the same time can be used for fixing the flexible fabric material and, if present, additional grid structures to the leg of the corresponding metal profile of the adjacent frame.

By providing this groove and tongue structure of the '470 Climeworks publication, at the same time a mechanical as well as tight sealing connection can be established and in addition to that the individual layers can be shifted into the stack easily in the production or replacement process.

Another preferred embodiment of the '470 Climeworks publication is characterized in that within the stiff rectangular frame structure there is provided a separate heat exchange element comprising the tubes for the heat transfer fluid as well as the metal sheets and which in itself can be provided with frame elements holding the heat exchange element together.

In other words the heat exchange element of the '470 Climeworks publication can be provided as a separate self-standing element which can be produced separately and which is then inserted into the stiff rectangular frame structure or around which the stiff rectangular frame structure is built in the manufacturing process.

The stiff rectangular circumferential frame structure of the '470 Climeworks publication can be formed by four metal profiles arranged pairwise mutually parallel, being U-shaped metal profiles having pairs of legs arranged essentially parallel to said inlet face of the layer and said outlet face of the layer, respectively.

One pair of metal profiles of the '470 Climeworks publication can be arranged with the groove portion of the respective U-shaped metal profile facing the inner side of the stiff rectangular circumferential frame structure and the other pair can be arranged with the groove portion of the respective U-shaped metal profile facing the outside of the stiff rectangular circumferential frame structure. Preferably the latter orientation of the metal profile is the one which runs perpendicular to the running direction to the tubes.

The tubes of the heat exchange element are preferably metal tubes, preferably aluminum or copper tubes, according the '470 Climeworks publication. These tubes can be provided with an inner diameter in the range of 3-20 mm, preferably in the range of 5-12 mm, and/or with an outer diameter in the range of 4-24 mm, preferably in the range of 6.2-14 mm.

The tubes of the heat exchange element are typically, where running parallel, spaced by a distance (x) in the range of 10-168 mm, preferably in the range of 15.5-98 mm, according the '470 Climeworks publication.

The sheets of metal according to a preferred embodiment of the '470 Climeworks publication have a thickness in the range of 0.1-0.4 mm, preferably in the range of 0.12-0.18 mm.

The sheets of metal according to another preferred embodiment of the '470 Climeworks publication have a height (h), measured perpendicular to the running direction of the tubes in the range of 3-50 mm, preferably in the range of 8-22 mm.

The sheets of metal according to a preferred embodiment of the '470 Climeworks publication have a length being less than 20 mm, preferably less than 5 mm shorter than the distance between the respective pair of metal profiles arranged pairwise mutually parallel forming said stiff rectangular circumferential frame structure.

Preferably the sheets of metal of the '470 Climeworks publication are made of aluminum.

Typically, the sheets of metal of the '470 Climeworks publication are spaced by a distance (d) in the range of 1-15 or 1-6 mm, preferably in the range of 3.5-7 mm or 4-5.5 mm.

As concerns the dimensioning of the tubes of the '470 Climeworks publication in the metal sheets the above mentioned values are an optimum compromise allowing for good interpenetration by the particulate sorbent material, also allowing filling of the structure in the manufacturing process, and on the other hand allowing for sufficient porosity for the air passing through the layer, and allowing for an efficient as possible heat transfer process for the heating and cooling steps in the cyclic temperature swing carbon dioxide capture process.

The flexible fabric material of the '470 Climeworks publication is preferably grid or a woven or nonwoven textile material, preferably based on metallic or polymeric fibers or yarns, respectively, most preferably based on fibers or yarns, respectively based on PET and/or PE, or the flexible fabric material is made from a cellulose based material, preferably a paper material.

In the present disclosure, the flexible fabric material as disclosed herein may be based on nonwoven materials that have been expanded to create the appropriate degree of porosity. These materials may be expanded PTFE (ePTFE) or expanded PE (ePE), for example. Both ePTFE and ePE have high degrees of hydrophobicity, which provide additional benefits as further disclosed herein.

The flexible fabric material of the '470 Climeworks publication can have a thickness in the range of 0.1-4 mm, preferably in the range of 0.15-1 mm, this in particular if it is chosen to be a nonwoven polyethylene based material.

In the present disclosure, the flexible fabric material as disclosed herein, for example the material based on the nonwoven materials such as ePTFE and/or ePE, may be formed as very thin membranes. The thickness of such membranes as generated or utilized may be at or less than 0.025 mm, for example. Benefits of reducing the thickness may include: 1) reducing the manufacturing cost such as material cost and shipping cost, and/or 2) reducing pressures required for air to cross the membrane, for example.

The flexible fabric material of the '470 Climeworks publication has, preferably in the form of a polyethylene grid or nonwoven, an air permeability in the range of 2500-5000 L/m²/s, preferably in the range of 3000-4000 L/m²/s. The flexible fabric material or at least the upstream facing layer thereof, or a separate upstream filter fabric material layer, has preferably the filtration properties of at least the filter class M5, preferably at least F6, more preferably F7 such that atmospheric solid particle pollutants in the PM10 and PM2.5 range can be effectively retained without entrainment into the sorbent material layer. The classification of the filter material as used herein is according to DIN EN 779, October 2012.

The filter fabric material has, in particular in case of class M5 material, preferably an air permeability in the range of 50-600 L/m²/s, preferably in the range 200-400 L/m²/s. In one embodiment of the '470 Climeworks publication, the surface area of the filter fabric material can be increased by pleating such that the cumulative surface area of the filter fabric material exposed to the gas inflow can be at least 3 times, preferably at least 6 or at least 10 times the surface area of the individual layers exposed to gas inflow thereby maintaining a pressure drop across said filter fabric material which does not exceed an allowable pressure drop for an efficient direct air capture process. The flexible fabric material can be pleated with pleat height of 1-12 mm, preferably 3-6 mm. The pleat spacing can be 0.5-5 mm preferably 1-3 mm.

According to another embodiment of the '470 Climeworks publication, the filter fabric material can be mounted to the stiff rectangular circumferential frame structure of the individual sorbent material layers, preferably in a removable fashion such that it may be exchanged when fully charged with atmospheric particle pollutants. According to yet another embodiment of the '470 Climeworks publication, the filter fabric material can be mounted on a rectangular frame structure such that said filter fabric material can be mounted and dismounted independently of the sorbent material layers when it needs to be exchanged.

In the present disclosure, the flexible fabric material as disclosed herein may be permanently mounted, attached, fastened, or adhered to the frame (such as through adhesion provided by adhesives, or any other suitable attachment means), yet still capable of providing access to the interior of the frame without removing the mounted fabric material. Features such as zippers, clasps, and/or locking closures (such as those found on Zip-lock bags), for example, may be utilized to access the interior to allow filling and removal of sorbent. Such “quick access” features will be beneficial in increasing speed and efficiency of maintenance, thereby facilitating a more efficient system operation.

According to yet another preferred embodiment of the '470 Climeworks publication within the stiff rectangular circumferential frame structure and preferably across the heat exchange element as well as the layers of flexible fabric material, and, if present, wire grid layers, there is provided a plurality of attachment elements, preferably in the form of glue or welding or soldering or center rivet connections or transverse or longitudinal slats affixed with any of these means for holding at least the flexible fabric material layers together (if attachment elements penetrate across the heat exchange element) or the flexible fabric material layer attached to the metal sheets and/or the tubing. Again this is to prevent sagging of the flexible fabric layers, improving stability and improving control over hole formation

Preferably, according to the '470 Climeworks publication, said center rivet connections each comprise a rivet tube and a rivet pin, said rivet tube penetrating through the heat exchange element and between said metal sheets, said rivet tube and rivet pin each being provided with a head being located outside of the flexible fabric material, and, if present, and outermost wire grid layer. In the production process preferably first holes are generated through the structure provided by the parallel running metal sheets, and then into these holes the rivet tube is inserted from one side, and the rivet pin is inserted from the other side.

Preferably, according to the '470 Climeworks publication, the outer diameter of the rivet tube of the center rivets is at least 10%, preferably at least 30% smaller than the distance (d) of the metal sheets. One reason for this is that when the corresponding structure is to be filled by the particulate sorbent material, it must be made sure that the particulate sorbent material can actually penetrate through the interspace between two adjacent metal sheets. If these pathways are blocked by the center rivets, efficient filling of the structure is not possible. In any case such a filling process typically involves blowing the particulate sorbent material into the interspace and the cavity of the frame, assisted by shaking of the structure and/or other action allowing for settling of the particulate sorbent material in the cavities between the metal sheets and/or the tubes.

According to yet another preferred embodiment of the '470 Climeworks publication, said plurality of center rivet connections are arranged in a staggered arrangement avoiding that more than one or more than two center rivets are located in the same interspace of two adjacent metal sheets. Staggered in this sense means that said plurality of center rivet is not arranged along lines which run parallel to the corresponding running direction of the metal sheets, but along lines which are slightly tilted relative to the running direction of the metal sheets. Preferably the center rivet connections are arranged along lines along the general direction of the metal sheets and are inclined under an angle of at least more than 2° thereto but not more than 10° thereto. Further the center to center distance of neighboring rivets is preferably in the range of 2.5-20 cm or 5-20 cm, preferably, 7-12 or 8-10 cm.

Mutually adjacent and contacting layers of the stack of the '470 Climeworks publication can be pairwise held by horizontally extending support elements in particular at contacting edges of adjacent layers, wherein preferably, in particular at the upstream edges of the stack, the support element is provided with an aerodynamically shaped nose portion facing upstream (with respect to the inflow), and wherein further preferably the support element comprises a pair of outer leg portions running essentially parallel to the outer plane of the respective layer, and a central leg portion located in between. The mounting arrangement, which will be further detailed below, in a carbon dioxide capture unit is as such and independent of the frame structure.

Along the stack of layers of the '470 Climeworks publication the distance between adjacent layers can be varied taking account of the pressure drop profile of the inflow along a direction parallel to the direction of inflow. In case of a central inflow the distance (a) on the opening side between two adjacent layers of the stack is set at a given value (a) in the range of 8-230 mm, preferably in the range of 19.2-200 mm or 20-100 mm. The stack can be arranged such that the distance (a) between two adjacent layers increases outwardly to a value (c) within the range in the range of 8-230 mm, preferably in the range of 19-200 mm or 20-100.

Also it is possible to gradually increase the angle of the layers of the '470 Climeworks publication to a main horizontal axis of the unit, namely in case of a central inflow preferably this angle is gradually increasing from a value of around zero at the center to a value in the range of 0-20°, preferably in the range of 0.1-5°.

Typically, the proposed unit of the '470 Climeworks publication is located in a housing, said housing being preferably provided with turbulence reducing elements in particular upstream of the stack of layers.

Further the disclosure of the '470 Climeworks publication relates to the use of a unit as described above for extracting carbon dioxide from air and/or flue gases and/or biogas and/or other CO₂-containing gas streams.

According to yet another preferred embodiment of the '470 Climeworks publication, the layers of the stack of at least two layers are held together in a housing by at least a pair of side walls.

The sidewalls of the '470 Climeworks publication can either be arranged pairwise vertically (in which case the frame elements are arranged essentially horizontally) or pairwise horizontally (in which case the frame elements are arranged essentially vertically).

On the side walls of the '470 Climeworks publication the lateral metal profiles are fixed by using a form fit connection, a force fit connection or by means of a closure by adhesive force. Preferably the side walls are provided with a pattern of fixing elements to allow for fixing the lateral metal profiles on the respective side wall in the desired relative positions. The corresponding patterning of the fixing elements is therefore adapted to the desired orientation of the frames in the stack. It is for example possible to structure the pattern such that the distance between adjacent frames varies along the stack, such that in the central portion the distance between adjacent frames is smaller than in the outside portions of the stack, as this is for example illustrated in FIG. 8 of the '470 Climeworks publication discussed further below.

The fixing elements of the '470 Climeworks publication provided on the sidewalls are preferably structured as holes, grooves, ribs, and/or studs.

In conjunction with such sidewalls further preferably, according to the '470 Climeworks publication, the metal profiles themselves are provided with corresponding profile fixing elements, which can be distributed along the length of the metal profile. Preferably at least 3, more preferably at least 5 profile fixing elements can be provided on each metal profile. The profile fixing elements can be structured as holes, as blind rivet nuts, as studs, as a groove, or as a rib.

The sidewall of the '470 Climeworks publication is typically a metal plate with a thickness in the range of 2-10 mm. The sidewalls can be provided with bent over portions which are directed to the outside of the stack for further stabilization.

Using the sidewalls it is possible to provide for a separate stack unit of the '470 Climeworks publication which in itself is self-standing and can be removably and/or exchangeably put into the actual housing which provides for the corresponding structure to withstand the vacuum which is applied in the typical cycle for the carbon dioxide separation. If the sidewalls are supplemented by a bottom wall and the top wall or plate, such as stack unit can be made essentially gas tight and sealed except for the inlet cross section and the outlet cross section allowing for a simplified structure also within the housing.

The use of such sidewalls to provide for a separate stack structure which can be put into the actual housing which is adapted for the vacuum cycles is as such a disclosure of the '470 Climeworks publication with its merits and advantages, in particular independent of the above-mentioned specific features of the layers with the circumferential frame structure etc.

### BRIEF DESCRIPTION OF THE DRAWINGS

Preferred embodiments of the disclosure are described in the following with reference to the drawings, which are for the purpose of illustrating the present preferred embodiments of the disclosure and not for the purpose of limiting the same. In the drawings,

FIG. 1 (prior art) shows a schematic cut along a direction perpendicular to the running direction of the heat exchange tubes through a particulate sorbent structure layer element with heat exchange element;

FIG. 2 (prior art) shows a schematic cut along a direction parallel to the running direction of the heat exchange tubes through the particulate sorbent structure layer element according to FIG. 1;

FIG. 3 (prior art) shows a cross-section of an embodiment of a stack of layer elements with the corresponding airflow indicated;

FIG. 4 (prior art) shows in a) a top view onto a heat exchange element and in b) a cut perpendicular to the running direction of the tubes without the actual frame structure;

FIG. 5 (prior art) shows a perspective view onto an edge portion of a particulate sorbent structure layer element;

FIG. 6 (prior art) in a) shows a cut in a direction perpendicular to the running direction of the metal sheets in the heat exchange element through a particulate sorbent structure layer element showing the center rivet arrangements penetrating the structure, in b) shows a perspective view onto one whole particulate sorbent structure layer element visualizing the placing of the center rivet elements, in c) shows the same as b) in a schematic representation from top and in d) shows a particulate sorbent material layer element with a denser rivet placing;

FIG. 7 (prior art) shows a schematic cut through the mounting region of the layer elements at the upstream edge portion of a stack;

FIG. 8 (prior art) a) shows a schematic illustration of a vertical cut through a whole stack with varying distance between the layer elements, b) a more detailed vertical cut through the inlet portion of the housing and c) a front view of the inlet portion of the housing;

FIG. 9 (prior art) shows a schematic illustration of a vertical cut through a whole stack with varying angle of the layer elements;

FIG. 10 (prior art) shows a schematic illustration of a pleated filter material fabric attached to particulate sorbent layer element;

FIG. 11 (prior art) shows in a) a cut though an upstream nose profile, in b) a top view and in c) a front view thereof;

FIG. 12 (prior art) shows a vertical axial cut through several different upstream nose profiles (left) and a stack with profiled upstream nose profiles in the outer regions of the stack (right);

FIG. 13 (prior art) shows a more detailed representation of a whole frame structure, wherein in a) a side view from a first lateral side (filling side, right edge in top view b), to be attached to a side wall) is shown, in b) a top view is shown (with omission of the heat exchange metal sheets/lamella for better visibility of the other structural elements), in c) a side view from a second lateral side (left edge in top view b), to be attached to a sidewall), in d) the cut along B-B are shown;

FIG. 14 (prior art) shows the right side wall of a whole stack in a) in a side view from the inside of the stack, in b) in a top view and in c) in a front view;

FIG. 15 (prior art) shows a perspective representation of the whole stack from the outflow side with left sidewall and frames in a) and in b) a cut along the lines A-A in a);

FIG. 16 (prior art) shows an embodiment in a) in which the particulate sorbent material layer elements can be shifted into the frame of the stack by way of U-shaped profiles and in b) and embodiment by way of wedges;

FIG. 17 (prior art) shows an embodiment in a) in which the particulate sorbent material layer elements are in a horizontal position in the frame of the stack and can be shifted into the frame by way of a groove/tongue mechanism, in b) an embodiment in which within the frame of the stack in a transverse direction two particulate sorbent material layer elements are located next to each other, by way of a vertical separation wall, and in c) an embodiment in which the particulate sorbent material layer elements are in a vertical position in the frame of the stack and can be shifted into the frame by way of a groove/tongue mechanism.

FIGS. 18A and 18B show cross-sectional diagrams of particulate sorbent material constructs according to embodiments disclosed herein.

FIGS. 19A through 19C show cross-sectional diagrams of particulate sorbent material constructs as well as flow of air/gas, fluid, and/or pressure within the constructs according to embodiments disclosed herein.

FIGS. 20A and 20B show cross-sectional diagrams of particulate sorbent material constructs according to embodiments disclosed herein.

FIG. 21 shows a cross-sectional diagram of a particulate sorbent material construct with conductors embedded in the conduits according to embodiments disclosed herein.

FIGS. 22A through 22E show different steps in a process of forming or constructing a gas separation unit using the constructs according to embodiments disclosed herein.

FIG. 23 is a photograph of a particulate sorbent material construct according to embodiments disclosed herein.

FIG. 24 is a photograph of a particulate sorbent material construct with conductors embedded in the conduits according to embodiments disclosed herein.

FIGS. 25A and 25B show angled view of a particulate sorbent material construct with a resealable opening according to embodiments disclosed herein.

FIGS. 26A and 26B show angled view of a particulate sorbent material construct with a resealable opening according to embodiments disclosed herein.

FIG. 27 (prior art) shows TEM images, (a) through (d), of particles of two exemplary inactive materials with differing magnifications (each of the images is to the scale shown in the image).

FIGS. 28A through 28C show cross-sectional diagrams of a porous inactive material particle before and after a soluble sorbent material coating is applied to a surface to form a porous active material particle to be implemented in particulate sorbent material constructs according to embodiments disclosed herein.

FIGS. 29A and 29B are SEM images of the surface structures of a porous material before and after the soluble sorbent material coating is applied (each of the images is to the scale shown in the image).

### DETAILED DESCRIPTION

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

The term “fibril” as used herein describes an elongated piece of material such as a polymer, where the length and width are substantially different from each other. For example, a fibril may resemble a piece of string or fiber, where the width (or thickness) is much shorter or smaller than the length.

The term “node” as used herein describes a connection point of at least two fibrils, where the connection may be defined as a location where the two fibrils come into contact with each other, permanently or temporarily. In some examples, a node may also be used to describe a larger volume of material than a fibril and where a fibril originates or terminates with no clear continuation of the same fibril through the node. In some examples, a node has a greater width but a smaller length than the fibril.

As used herein, “nodes” and “fibrils” may be used to describe objects that are usually, but not necessarily, connected or interconnected, and have a microscopic size, for example. A “microscopic” object may be defined as an object with at least one dimension (width, length, or height) that is substantially small such that the object or the detail of the object is not visible to the naked eye or difficult, if not impossible, to observe without the aid of a microscope (including but not limited to a scanning electron microscope or SEM, for example) or any suitable type of magnification device.

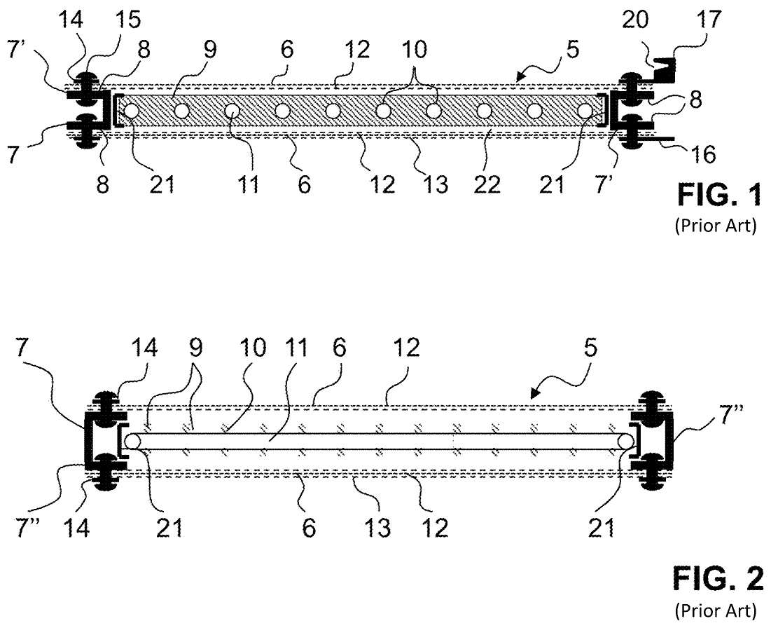

FIG. 1 of the '470 Climeworks publication shows a schematic cut through a particular absorbent structure layer element 5 in the horizontal orientation with heat exchange element, said cut being along a direction perpendicular to the running direction of the heat exchange tubes 11. FIG. 2 of the '470 Climeworks publication shows the corresponding cut in a direction perpendicular to the one as shown in FIG. 1 of the '470 Climeworks publication. It should be noted that the running direction of the heat exchange element tubes 11 can also be different, i.e. it is also possible that the heat exchange element 22 is rotated by 90 degrees within the frame structure.

There is provided a rigid rectangular frame structure formed by two pairs of mutually parallel frame profiles 7′ and 7″. One first pair 7′ is each provided as a U-shaped aluminum profile with the groove of the corresponding U-shape facing outwardly (see FIG. 1 of the '470 Climeworks publication). So the two legs 8 of the corresponding profile 7 are facing outwardly and are arranged parallel to the main plane of the corresponding layer 5.

The other pair of frame profiles 7″ as illustrated in FIG. 2 of the '470 Climeworks publication is located perpendicular to the first pair of profiles 7′ is arranged such that the corresponding groove of the U-shaped profile is facing inwardly and is partly enclosing the heat exchange element 22 located in the interspace between the two pairs of frame profiles 7′ and 7″.

Between the two pairs of frame profiles or rather the four profiles and circumferentially enclosed thereby there is located the heat exchange element 22. This heat exchange element 22 in itself is a self-standing heat exchange element provided with a plurality of thermal transfer medium tubes 11 which are running parallel to each other and which are spaced from each other. Running perpendicular to these tubes 11 there is provided a plurality of metal sheets 9, which essentially extend over the full width and bridging almost the distance between the respective frame profiles 7, as can be seen in FIG. 1 of the '470 Climeworks publication. These metal sheets 9 are provided each with a plurality of holes 10 through which the tubes penetrate. The metal sheets 9 as well as the tubes 11 are made of aluminum and the tubes 11 tightly fit into and contact the edges of the holes 10 so that there is a good thermal contact between the metal sheets 9 acting as thermal transfer elements and the tubing 11.

Each layer 5 comprises on its top side first a layer of wire grid 12 which is essentially touching the heat exchange element 22, or rather the edges of the plurality of metal sheets 9 thereof. On the outer side of this inner wire grid layer 12 there is provided a sheet of flexible fabric material, typically a non-woven PE material, which avoids that the sorbent material, which is also located in the interspace and surrounding the heat exchange element 22 is contained within the layer 5 but nevertheless the whole structure is air permeable.

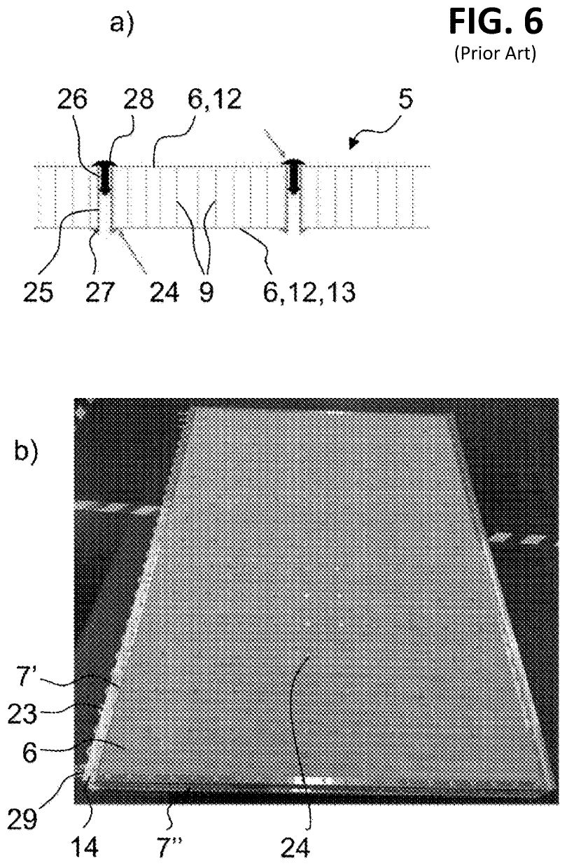

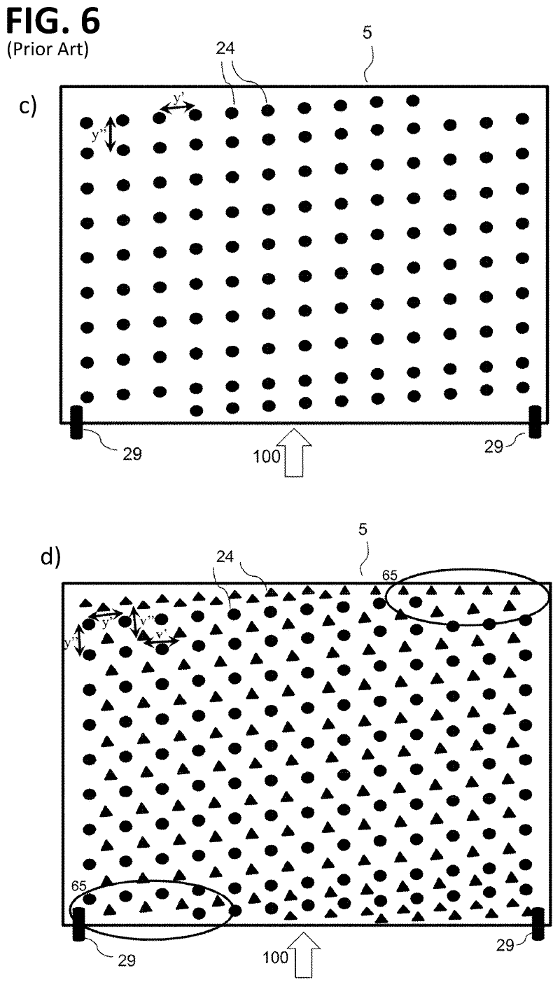

In this horizontal orientation, on the bottom side there is in addition provided a further outer wire grid layer 13 on the outer side of the respective flexible fabric material layer, avoiding sagging of the layers 6 and 12 on the bottom side. Further, this sagging is avoided by providing the penetrating center rivet connections as are illustrated in FIG. 6 of the '470 Climeworks publication and as will be detailed further below.

The aluminum tubes 11 are running parallel to each other, and at the terminal portions they are forming a U-shape in U-turns so that the thermal transfer medium is contained and guided in these tubes 11 in a meandering manner. Also the heat exchange element 22 in itself comprises a frame structure 21. This can be again a U-shaped frame structure as illustrated in FIGS. 1 and 2 of the '470 Climeworks publication and indicated with reference 21, however, in particular in the dimension as illustrated in FIG. 2 of the '470 Climeworks publication it is not necessary to have such a U-type structured frame element for the heat exchange element. It can there be sufficient to have on each side of the tubes 11 a slat which is directly contacting and attached to the corresponding tube 11. Also, it is possible that the U-shaped bent portions 23 of the tubes 11 are not located within the corresponding frame structure 21 but penetrate through such that the bent portions of the tubes 11 are located outside of the corresponding frame structure 21 of the heat exchange element.

The layers 6, 12 and 13 are attached to the legs 8 of the respective U-shaped frame profile by means of slats 14 and rows of rivets 15. The slats 14 extend over essentially the length of the corresponding U-shaped profile and between the respective slat and the leg 8 of the profile there is located the respective part of the flexible fabric layer 6 and of the wire grid layer 13 or 12/13. In order to have a sufficiently stiff slat structure, they have a thickness in the range of 0.5-2.5 mm and a width in the range of 5-15 mm in cross-section, and the rivet spacing along the profile is in the range of 3-15 cm, preferably in the range of 2-7 cm.

This provides for a simple manufacturing process in that in a first step the heat exchange element is provided, then the frame profiles 7′ and 7″ are built around and in the following step the inner grid 12 is laid onto the legs 8 of the profiles, subsequently the flexible fabric layer 12 is laid on top of this layer, and then under applying the required tension, in particular to the flexible fabric layer 12, the slats 14 are pressed against the legs 8 so as to maintain this tension and to clamp the layers, and subsequently the rivet connections 15 are generated along the length of the respective profile all along the circumference of the frame structure.

It should be noted that in these representations the actual sorbent material, so the fine particles which are provided with amine-functionality to chemically capture the carbon dioxide is not illustrated. In practice this fine particulate sorbent material is completely filling the cavity within the 2 outer flexible fabric layer 6 and the frame structure. Typically this sorbent material is introduced through at least one hole in the vertical wall joining the legs 8 of one of the profiles, typically of a profile of the type 7′. In this filling process, normally the whole frame is tilted such that this opening for the filling is facing upwards, and then under application of pressurized air carrying the sorbent material this is blown into the into spaces between the metal sheets 9 and the tubes 11. In order to achieve a dense packing of the small particles a careful filling process is important, as the packing of the metal sheets is quite dense.

Typically the width of such a frame Wf is in the range of 1.4 m, and the depth Dft is in the range of 1 m, while the height of the frame is in the range of 20 mm, so the spacing between the flexible fabric layer 6 is in the range of 19 to 20 mm. The distance between adjacent tubes where they are running parallel is around 25 mm, and the distance between the metal sheets running parallel is around 5 mm. The thickness of the metal sheets is normally about 0.15 mm. The outer diameter of the tubes is normally around 10 mm, so that typically in the heat exchange element 22 there is a void fraction of 18-20%. The residual free flow through area is in the range of 55 to 60%. If the construction is made of aluminum (frame, slats, tubing, metal sheets, rivets) the thermal mass of an exchange element is in the range of 0.8-0.9 kJ/(K kg_{sorbent}). The maximum free heat length in the sorbent material is then around 5 mm.

For the flexible fabric layers a nonwoven polyester material of a thickness in the range of 0.15-0.2 mm is used, with an air permeability of around 3300 L/m²/s. For the metal grid a wire grid of aluminum is used with a wire spacing of around 1.15×1.35 mm. For both the inner and the outer metal grid 12 and 13, respectively the same type can be used.

As disclosed herein, a multi-layered flexible fabric material can be used in which each layer incorporates the needed features. For instance, a thin membrane of ePTFE or ePE measuring inclusively within the range of 0.01 to 0.05 mm may be laminated to a more durable backer (such as nonwoven PE). This laminate may then be laminated further to a metal or polymer grid (for support). A unique benefit to this laminate flexible fabric layer is the absence of relative motion between components. Relative motion during pressurization and vacuum steps of the operating cycle can introduce wear on the flexible fabric material (for example in the instance of the wire mesh and fabric embodiment stated supra). Also, in the example of the laminated flexible fabric material, it will be beneficial for all externa-facing features to have a high degree of hydrophobicity. Shedding any condensation created during adsorption/desorption and cooling step is very important to reduce cycle times. Improving drying time will have a positive effect of system performance.

One particular feature providing for optimum sealing and mechanical connection for adjacent layers 5 touching along one edge is also illustrated in FIG. 1 of the '470 Climeworks publication. It is possible to have slats 16 of extended width (in a direction of the legs 8) extending beyond the edge of the legs 8 of the frame profile 7′. Likewise, it is possible to have also such wide slats which are however in addition to that provided with a sealing protrusion 17 having a groove 20 for receiving the protruding portion of the larger width slat 16.

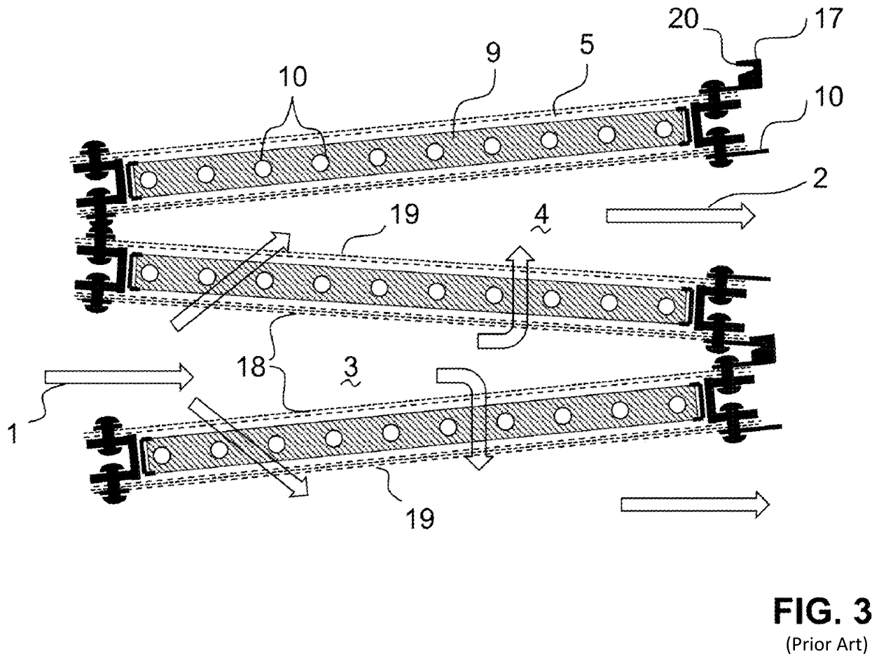

How this can be used for sealing and attaching adjacent rigid frame structure or layers 5 is illustrated in FIG. 3 of the '470 Climeworks publication. In this FIG. 3 of the '470 Climeworks publication, a whole stack of such layers 5 is illustrated and it can be seen in the bottom arrangement of the lowermost tube layers that the protruding tongue of the wide slat 16 can be inserted into the groove 20 for easy sealing and mechanical attachment of adjacent layers.

Also illustrated in FIG. 3 of the '470 Climeworks publication is the main gas flow in such a stack. The gas inflow 1 enters the inlet gas channel 3 and subsequently the air penetrates through each of the layers and therefore through the heat exchange element and in particular through the bed of sorbent particles located in the interspace. Under the correspondingly chosen conditions of pressure, temperature and humidity, the carbon dioxide is captured normally by the amine functionalities located on the surface and/or in the porosity of the sorbent particles. It is to be noted again that the sorbent material is not specifically illustrated in FIGS. 1-3 of the '470 Climeworks publication. After having passed through the corresponding layer under depletion of carbon dioxide, the air enters the downstream side of the respective layer, i.e. the gas outlet channel 4 before it is then exiting the system as the gas outflow 2.

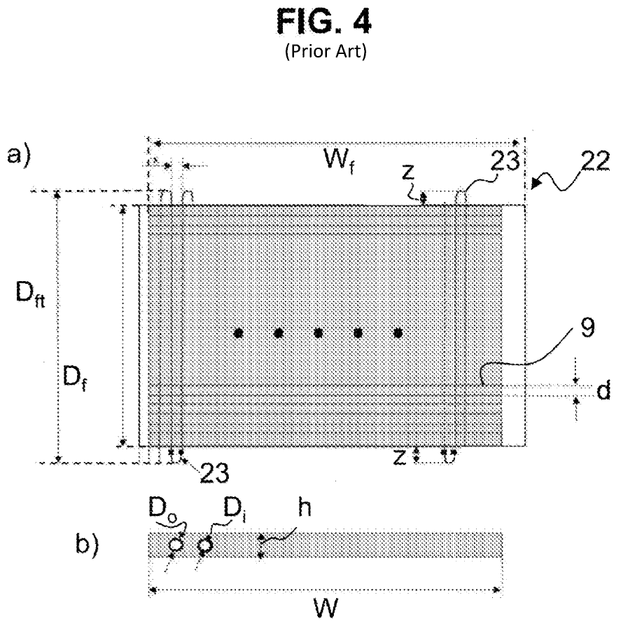

A heat exchange element 22 is illustrated in a top view schematically in FIG. 4a of the '470 Climeworks publication and in a cut view in 4b of the '470 Climeworks publication. As one can see, in this embodiment the frame structure 21 of this heat exchange element 22 is arranged such that the U-turns 23 of the tubes 11 are located outside of the frame structure 21. Typically, the protruding length z of these U-turns of the tubes 11 is in the range of 5-30 mm. The distance between adjacent metal sheets 9 of the pack of parallel metal sheets in the heat exchange element is in the range of typically 4.8 mm, so these metal sheets are rather closely spaced in order to reach a low maximum free heat length in the sorbent material. The distance between adjacent metal sheets and also in the tubing is further carefully chosen such that the sorbent material can penetrate in the interspace and is still not pressed therein in a manner avoiding flow through of the air. On the other hand, the tubes are spaced by distance x, which is typically in the range of 25 mm.

The height of the corresponding metal sheets h is normally in the range of 3-50 mm, a good flow through can be made possible by having a height in the range of around 15-20 mm at the same time maintaining an optimum heat transfer and low thermal mass.

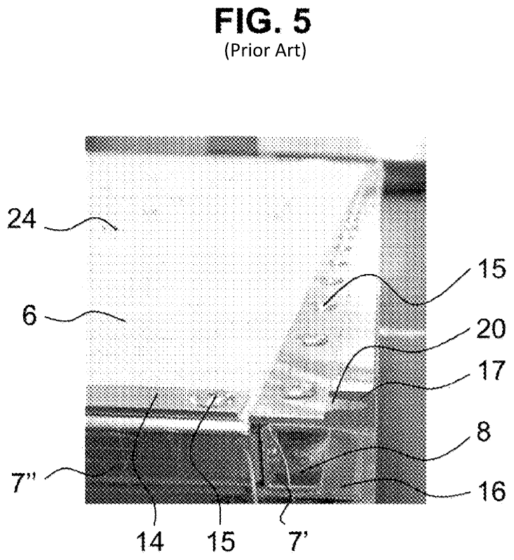

An edge portion of a corresponding layer 5 is illustrated in FIG. 5 of the '470 Climeworks publication. In this illustration the details of the protrusion 17 and of the wide slat 16 are shown and also how, according to this different embodiment, at the end the U-shaped profiles 7′ and 7″ are attached to each other.

In FIG. 6 of the '470 Climeworks publication, the above mentioned center rivet connections are shown. In FIG. 6a of the '470 Climeworks publication a cut though the layer structure 5 is shown. As one can see, the central rivet connections each comprise a rivet tube 25 which fully penetrates the whole structure i.e. the flexible fabric sheet 6, the wire grid 12 on the top side, the metal sheets 9, and on the bottom side the layers 6, 12 and 13. The outer diameter of this rivet tube 25 is preferably chosen such that it is sufficiently smaller than the distance between adjacent metal sheets. The important aspect to watch out for is that the outer diameter of the rivet tube 25 is sufficiently small compared to the distance between metal sheets and compared to the average particle diameter of the particulate sorbent material so that the filing of the structure with particulate sorbent is possible without any blocking of the channels between adjacent metal sheet and the central rivet connections.

These rivet tubes 25 are inserted after an initial “drilling” or widening of a hole in a first manufacturing step, then the rivet tube 25 is inserted into these pretreated openings, and then from the other side a rivet pin 26 is inserted into the opening of the tube 25 and the rivet is fixed. Each, rivet tube 25 and rivet pin 25, are provided with a rivet head 27 and 28, respectively having a larger diameter than the outer diameter of the rivet tube, so that these head portions 27 and 28 provide a safe form fit connection of the layers 6, 12 and 13. The length of the rivet tube 25 should be adapted to essentially match the height h of the metal sheets.

FIG. 6c of the '470 Climeworks publication shows the particulate sorbent material 5 in a perspective view illustrating the rivet distribution. FIG. 6c of the '470 Climeworks publication shows the same in a schematic representation and illustrating the spacing y″ of the rivets 24 in the longitudinal direction (essentially parallel to the main flow 100), and the spacing y′ in the transverse direction (essentially perpendicular to the main flow 100). The values for y′ and y″ in this exemplary embodiment are set to 10 cm.

An alternative and denser rivet pattern is illustrated in FIG. 6d of the '470 Climeworks publication. In this embodiment the y′ and y″ spacing of the rivets 24 is set at 10 cm as in previous Figure of the '470 Climeworks publication. There is however provided an additional second group of rivets (illustrated by triangles as opposed to the circles representing the first group) with v′ and v″ spacing of these additional rivets 24 set at 10 cm shifted compared to y′ and y″ spacing. The effective maximum spacing between the rivets in this case is then 7.5 cm. In addition to that, extra rivets are provided in zones 65 to prevent bulging in zones where in the pattern according to FIG. 6c of the '470 Climeworks publication no rivets were present. In the zones 65 the maximum spacing of rivets 24 set at 5 cm improving stability of the layer and improving control over hole formation.

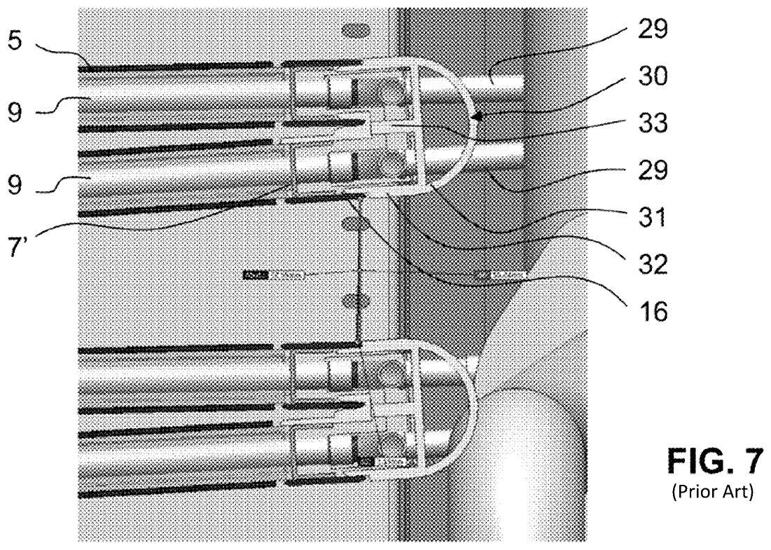

In FIG. 7 of the '470 Climeworks publication the tip portion of a stack of layers 5 is illustrated and in particular the corresponding support element 30 for attaching a layer 5 to a large frame structure of a housing in which the corresponding unit is arranged. These support elements 30 are provided as aerodynamic as well as mechanical construction elements. They comprise a round nose portion 31 which avoids turbulence and makes sure that the inflow and/or outflow, depending on the side, is essentially free from turbulences leading to a lower pressure drop across the whole structure.

On the opposite side, these support elements 30 are provided with a pair of outer legs 32, adapted to interact with a corresponding wide slat 16 of the corresponding layer. There is further provided a central inner leg portion 33 which can be used to abut with protrusion 17. As one can see from this figure of the '470 Climeworks publication, the respective arrangement of the wide slat 16 and of the extended portions 17 can also be different from the situation illustrated in FIGS. 1 and 3 of the '470 Climeworks publication, so frame structures can be provided with pairs of wide slats on one side, as given in each of the top layers in the representation in FIG. 7 of the '470 Climeworks publication.

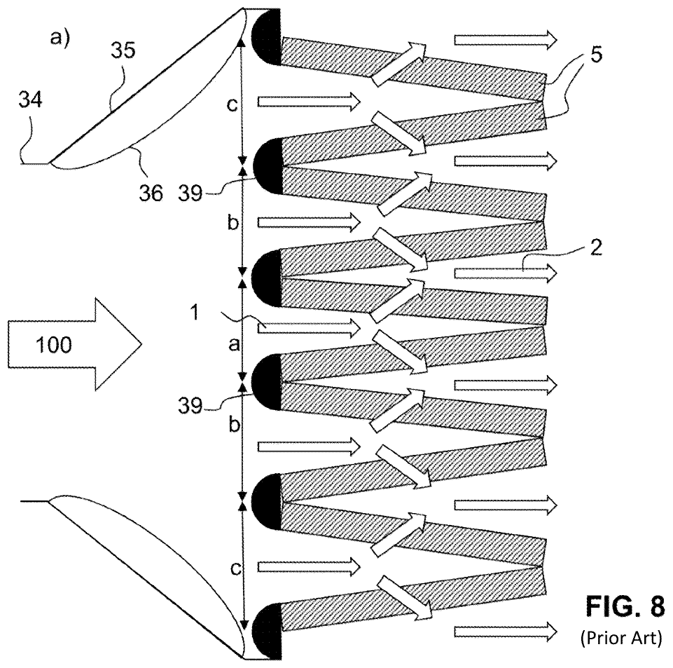

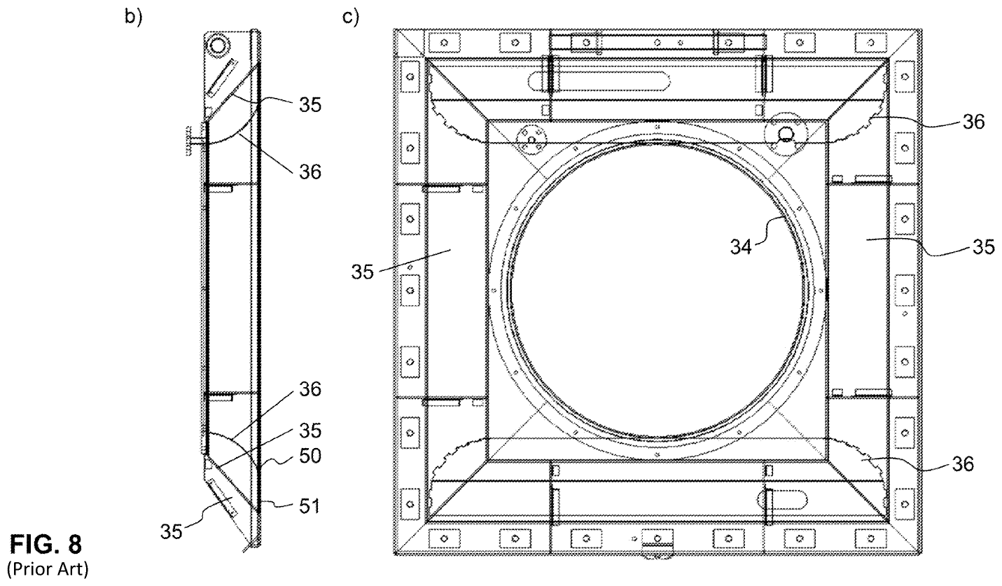

Aerodynamic optimization of such a stack of layers 5 is important for making sure there is not too high a pressure drop across the whole structure. This can be achieved in that the layers 5 are arranged as illustrated in FIG. 8a of the '470 Climeworks publication. In this arrangement, in a central portion (central in respect of the vertical direction) the distance between adjacent layers 5 is chosen to be smaller (value a) than in the outer regions, so the value of a is smaller than the value of b and the value of b is smaller than the value of c. As a matter of fact in case of a central inflow 100 there is, in a direction perpendicular to this inflow, a pressure drop, i.e. the pressure drops as a function of the distance to the axis of the structure. Increasing the distance between adjacent layers towards the outer region takes this into account and avoids that individual layers are differently efficient and flown through by air to a significantly different extent depending on their vertical position. Further, in order to again avoid turbulences it is possible to provide in a corresponding widening wall portion 35 of the inflow duct 34 turbulence reducing elements 36 provided as smooth bulging elements with round edges. Typically in such a stack the distance a varies from small values of around 35 mm to large values c of 80 mm. A stack typically has 25-60 layers. Around 30 layers have been shown to be particularly efficient for direct air capture.

The upstream contact regions of the layers 5 can also be aerodynamically structured in that an upstream nose profiles 39 are provided. These can be combined with the structural elements holding the upstream edges of the layers 5 in place.

As illustrated in FIGS. 8b and c of the '470 Climeworks publication the turbulence reducing elements 36 can be arranged so as to provide a smooth transition between the inflow duct 34 and the widening wall portion 35. The transition between 34 is such that the turbulence reducing elements 36 is tangential to the inflow duct 34. The downstream edge 50 of the shield 36 is not tangential to a radial portion 50 of the shield 36. The radius of the bent portion of the shield 36 is in the range of 100-300 mm, preferably around 200 mm.

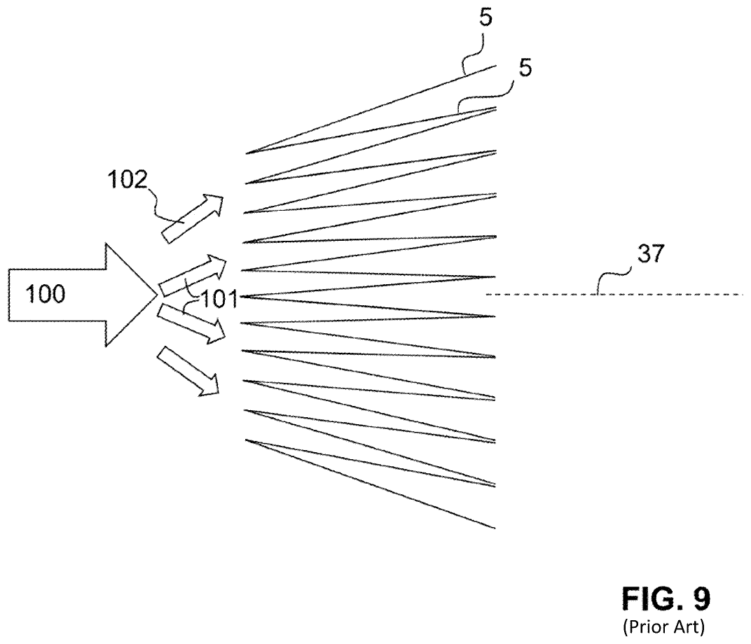

Another possibility for optimizing the efficiency and use of the corresponding layers 5 is schematically illustrated in FIG. 9 of the '470 Climeworks publication. Apart from or in addition to changing the spacing between adjacent layers it is also possible to adapt their inclination angle relative to a central inflow direction 100. So the angle of the layer 5 relative to the central axis 35 of the arrangement can be chosen to increasingly larger outwardly.

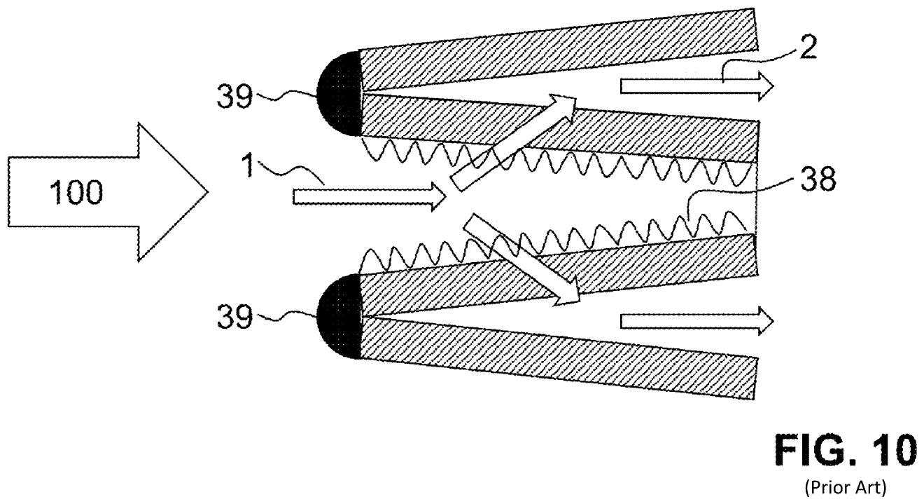

In FIG. 10 of the '470 Climeworks publication, the implementation of a filter fabric material 38 is illustrated. In this embodiment, the filter material is pleated to increase the flow through area and reduce pressure drop and is attached to the inlet faces of the particulate sorbent layer elements 5. Apart from or in addition to change the spacing of the pleats, it is also possible to change their height and thusly influence the effective flow through area and correspondingly the pressure drop.

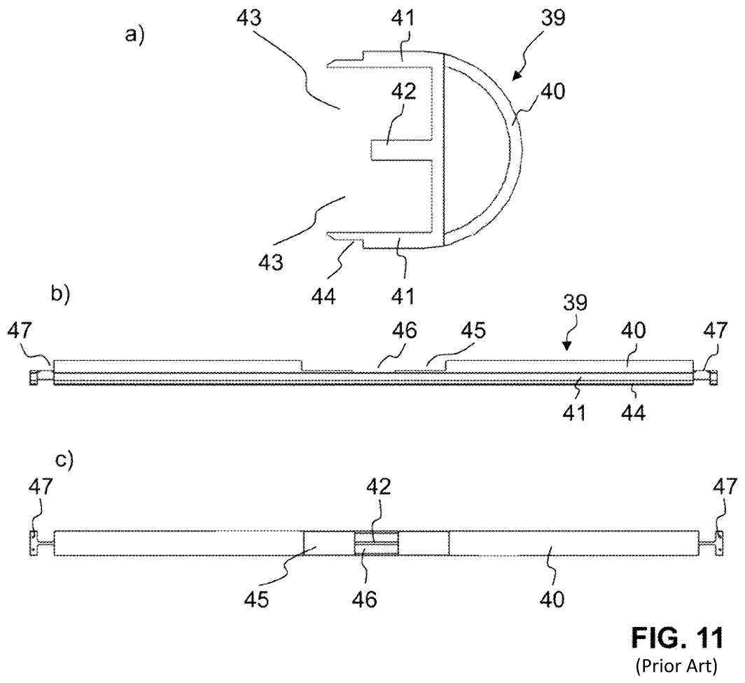

FIG. 11 of the '470 Climeworks publication shows the upstream nose profile 39, having a rounded nose portion 40 facing the incoming air flow and two outer lateral legs 41 and a central leg 42. The radius of the nose profile is about twice the thickness of the frame construction. Between the legs 41 and 42 there is provided a slot 43 into which the frames of the adjacent layers 5 can be shifted and fastened therein. For improved fixing and smooth transitions between the frames and the profile 36 there can be provided recesses 44 in the legs 41. In order to allow for opening of the flap door of the housing without collision with the nose profiles, the profiles 39 can be provided with recesses 45 and 46. The profiles 39 are fastened to the housing by means of the outer fastening means 47.

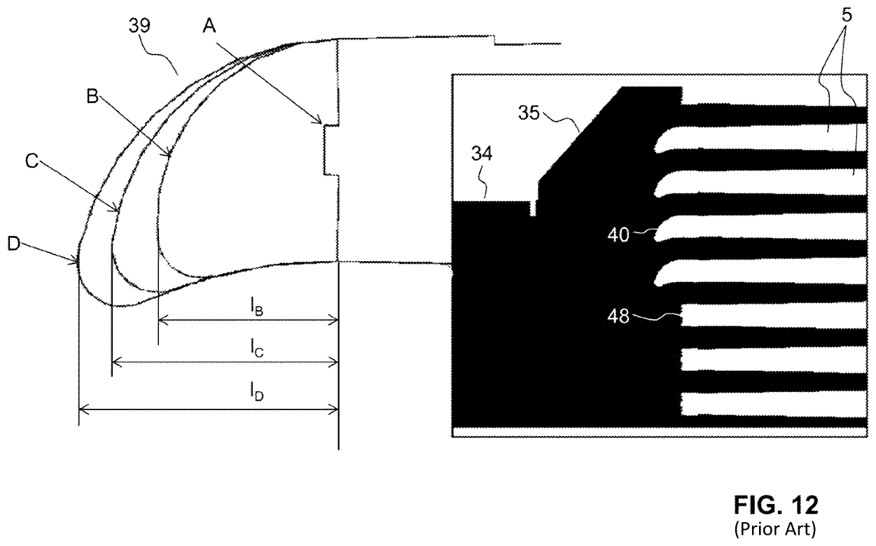

As shown in FIG. 12 of the '470 Climeworks publication within the stack not all of the front portions need to have nose portion, e.g. in the central portion of the stack fastening rails without rounded nose portion 48 can be provided. In the outer region there can be provided rounded portions 40, wherein these can be, as given in the left portion of FIG. 12 of the '470 Climeworks publication, of successively increasing or decreasing length, wherein the length of B can be around 40 mm, the length of C can be around 50 mm and the length of D can be around 58 or 60 mm.

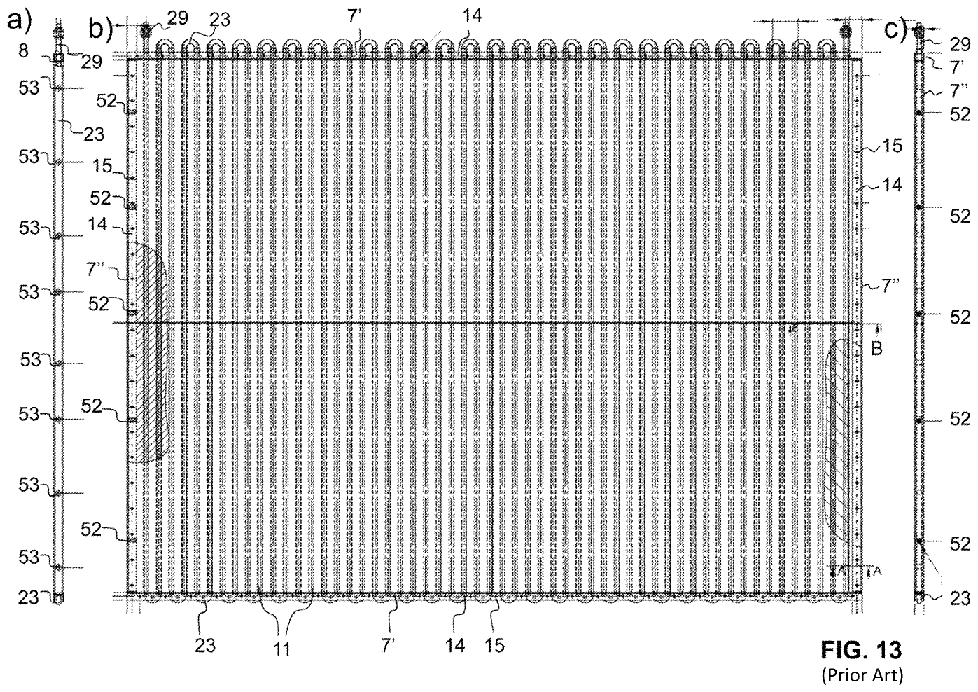

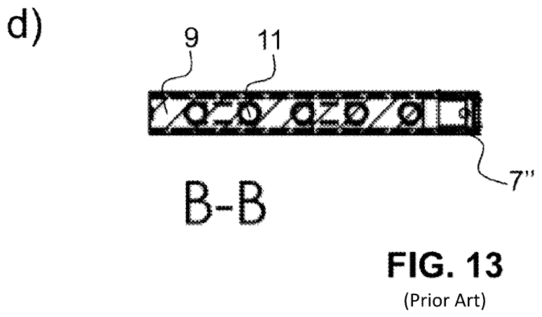

In FIG. 13 of the '470 Climeworks publication in somewhat more detail a frame structure is illustrated in various representations. The same reference numerals are used as in the other figures of the '470 Climeworks publication for the same or equivalent structural elements.

As one can see, the lateral frame elements 7″ on the left and on the right side, respectively, are structured differently: For the filling of the frame with the sorbent one needs a sufficiently large number of holes in the corresponding frame element 7″, while for fixing the whole frame on the sidewall of the stack (see FIG. 14 of the '470 Climeworks publication), a smaller number is required.

Therefore, the frame element 7″ on the left side in the representation according to b), which is illustrated in FIG. 13c) of the '470 Climeworks publication, is only provided with 5 openings, into which closed blind rivet nuts 52 are inserted for fixing the frame on the respective sidewall.

On the other hand, the frame element 7″ on the right side in the representation according to b), which is illustrated in FIG. 13a) of the '470 Climeworks publication, is provided with 8 holes at the positions indicated with the reference 53 in the bridging part of the U-profile. These holes are used for filling the cavity of the frame with the sorbent. Due to the fact that the heat exchange metal sheets 9 do not extend fully up to the frame element 7″, in an interspace parallel to the running direction of the frame element 7″ the sorbent can be distributed over the various interspaces between the heat exchange metal sheets 9 by using a number of openings in the frame element 7″ which is much smaller than the number of interspaces between the heat exchange metal sheets 9. Once the frame is filled with sorbent particles, the holes are closed with closed blind rivet nuts 53 as illustrated in FIG. 13a) of the '470 Climeworks publication.

Depending on the needs these blind rivet nuts 53 can now be used for fixing the frame on the respective sidewall, which in this case will be the right side wall for the profile illustrated on the left side of FIG. 13b) of the '470 Climeworks publication, since the upper side of the illustration in FIG. 13 of the '470 Climeworks publication is the inlet side and the lower side of the illustration in FIG. 13 of the '470 Climeworks publication is the outlet side of the usual frame mounting.

FIG. 14 of the '470 Climeworks publication shows a sidewall for putting together a whole stack of frames. The sidewall illustrated in this figure of the '470 Climeworks publication is the right side wall of the stack, looking in the travel direction of the air, and in a) it is illustrated in view from the inside of the stack, in b) in a bottom view, and in c) in a view from the left side in figure a). The frame elements 7″, which are illustrated in FIG. 13b) of the '470 Climeworks publication on the right side, and in a), are being attached to this sidewall plate 54. In order to attach the individual frame elements to the sidewall corresponding holes 56 are provided in the respective positions. Not all of the blind rivet nuts 53 are used for the fixing of the frame on the sidewall. As a matter of fact, of the 6 possible blind rivet nuts 53 illustrated in FIG. 13a) of the '470 Climeworks publication only 6 are used for attaching to the sidewall, namely the 3rd rivet nut 53 from the top and the 3rd rivet nut from the bottom is not used for fixing on the sidewall.

Schematic lines 57 indicate how the frame elements are mounted on the sidewall in a manner which is also illustrated in FIG. 3 of the '470 Climeworks publication. One can also recognize in this FIG. 14 of the '470 Climeworks publication that the orientation and the spacing of the frame elements is structured such that in the center portion the stacking distance a as illustrated in FIG. 8 of the '470 Climeworks publication is smaller than in the top region and the bottom region of the stack (corresponding to the distance c illustrated in FIG. 8 of the '470 Climeworks publication).

The sidewall plate 54 is also provided with bent over edges 59 on the two lateral sides and on the bottom side (bent over edge 60) for better stabilization of the side wall structure. The bent over edges 59 are pointing in an outward direction seen from the actual stack of frames. The width of these edges 59/60 is in the range of 20 mm. On the top of the plate there is no such edge but there is provided a cutout 58, into which the top cover plate can be placed in fixed to the corresponding side wall structure. To this end rivet nuts 55 are provided in the sidewall.

The corresponding sidewall on the left side is basically a mirror image of the sidewall illustrated in FIG. 14 of the '470 Climeworks publication, however since the pattern of the attachment closed blind rivet nuts 52 is different on that side (see FIG. 13c of the '470 Climeworks publication), the bore pattern is slightly different from the one illustrated in FIG. 14 of the '470 Climeworks publication.

In FIG. 15a) of the '470 Climeworks publication a perspective representation is given of a stack of frames now seen facing the flow direction of the air through the stack, so from the downstream side. The sidewall 54 visible on that representation is therefore the left side wall, which is also provided with bent over edges 59 and 56.

In a more detailed view in FIG. 15b) of the '470 Climeworks publication a cut along the line A-A in figure a) is illustrated. As in FIG. 15a) of the '470 Climeworks publication the actual attachment screw (usually including a washer) for attaching the frames through the holes 56 to the sidewall 54 is not illustrated. However in FIG. 15b) of the '470 Climeworks publication one can see how the heat exchange metal sheet 9 does not extend fully to the bottom of the U-profile of the frame element 7″, providing for the above mentioned possible distribution on filling with sorbent. On the other hand one can see that the blind rivet not 52 is located essentially parallel to the legs 8 of the profile 7″, and provides an inside threading for attachment through the bore 56 on the sidewall 54.

The arrangement given and shown in FIG. 15 of the '470 Climeworks publication using a sidewall according to FIG. 14 of the '470 Climeworks publication is for mounting a stack where the frames are arranged in an essentially horizontal direction. However, as pointed out above, the frames can also be mounted in a vertical direction, and in this case the sidewalls become top and bottom walls, respectively. In case of such a vertical arrangement also different attachment mechanisms for arranging the frame elements to form a stack are possible. For example it is possible to provide the bottom plate and the top plate in such a vertical arrangement with grooves in which the frame elements 7″ can be located, or into which these frame elements can be shifted in the mounting process. Also the inverse is possible, so it is possible to provide a groove in the respective frame elements 7″ and a corresponding rib on the respective top and bottom plate. Further it is possible to provide the bottom plate and the top plate with studs in the respective positions, and the frame elements 7″ are provided with rivet nuts, with or without internal threading. These rivet nuts can then be put onto the studs for attaching the respective frame to the top and bottom plate, respectively. Also the inverse is possible, so to have studs in the frame elements and bores or blind hole rivets in the top and bottom plate, respectively.

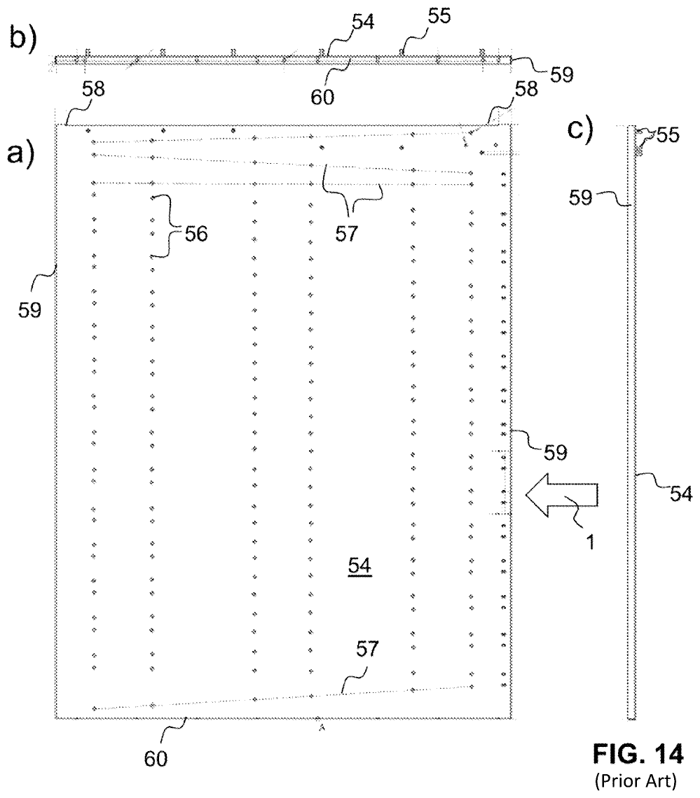

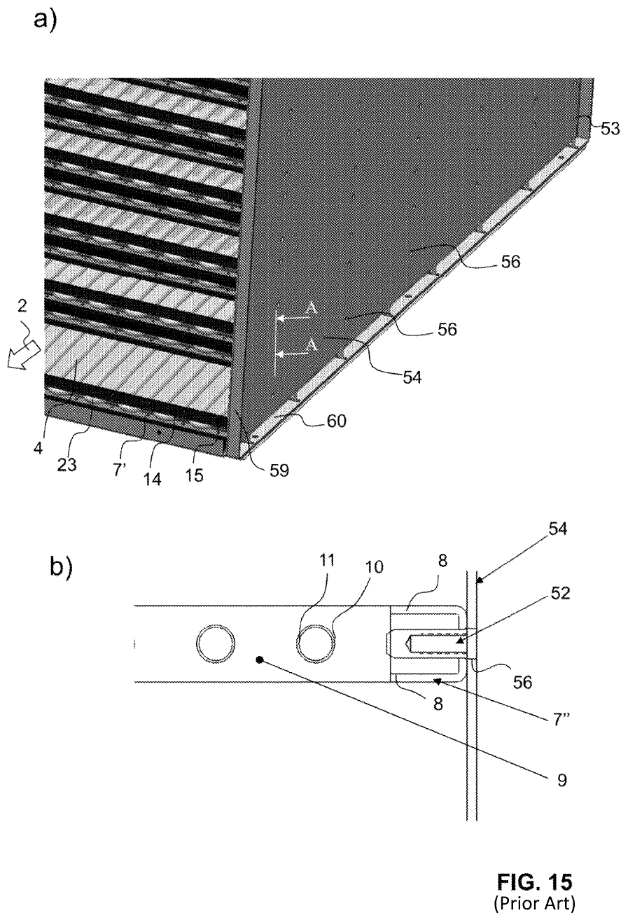

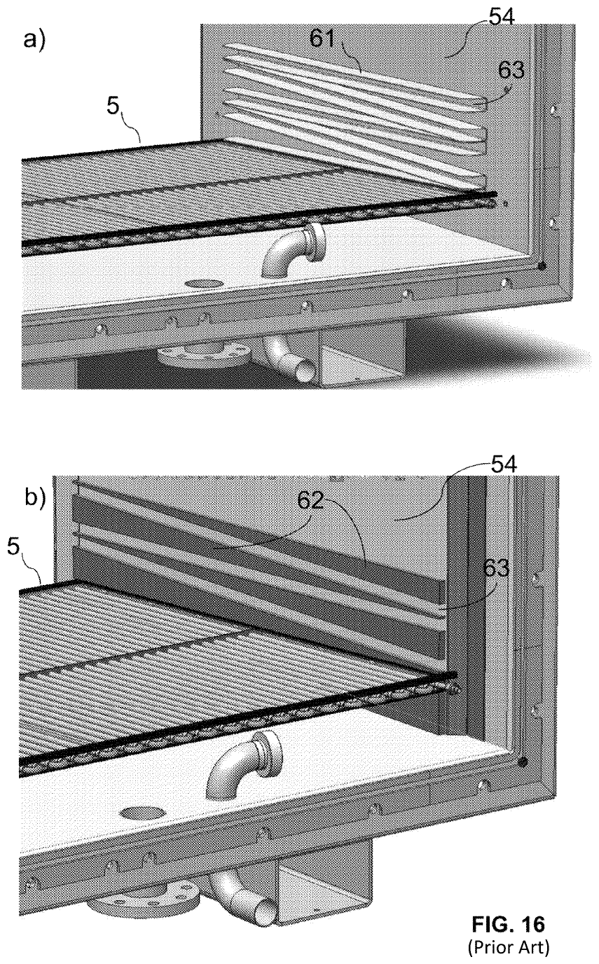

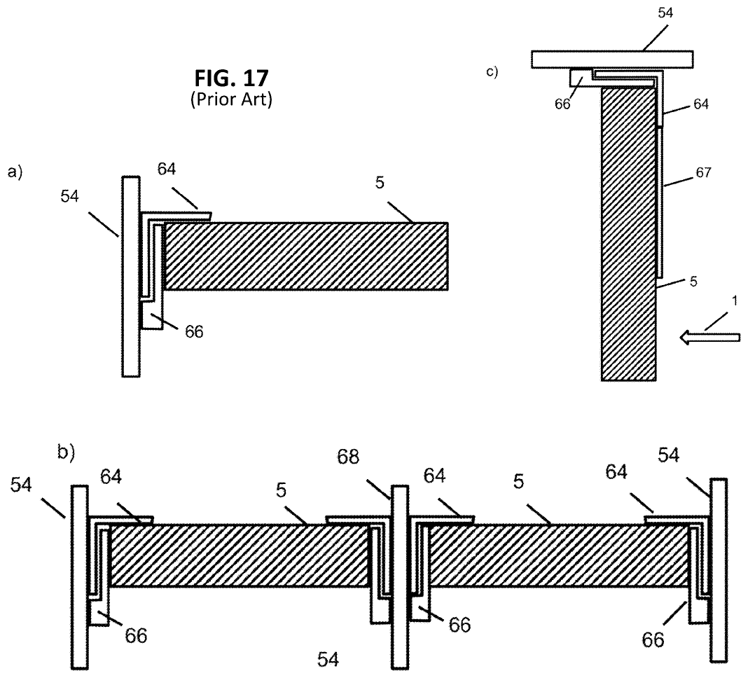

For the maintenance of the corresponding structure it can be important to be in a position to swiftly replace the particulate sorbent material layers 5 for example for regeneration or a replacement of the sorbent material. According to a preferred embodiment therefore the particulate sorbent material layers 5 are removably mounted in the stack frame structure. This is illustrated in FIGS. 16 and 17 of the '470 Climeworks publication.

In FIG. 16a) of the '470 Climeworks publication an embodiment of a drawer system, in which the particulate sorbent material layers 5 can be shifted into the frame like a drawer, is shown, where the sidewalls 54 are provided with U-shaped profiles firmly attached to the lateral walls 54 and providing for insertion grooves 63. The width of these insertion grooves 63 in a vertical direction is essentially the same or somewhat larger than the height of the corresponding particulate sorbent material layer 5. As in the previously illustrated examples, the layers 5 are oriented under inclination angles, so that inflow and outflow are optimized.

In FIG. 16b) of the '470 Climeworks publication an embodiment is shown, in which the interchangeable mounting of the layers 5 is realized by way of wedges 62 attached to the sidewalls 54. The wedges, which, in the longitudinal direction, are of opposite orientation, again provide for an arrangement of the layers 5 under inclination angles.

In FIG. 17 of the '470 Climeworks publication an embodiment of a drawer system for the particulate sorbent material layers 5 is shown in a horizontal a) and a vertical c) orientation. The drawer tongue 64 is fixed to the particulate sorbent material layer 5 and slides in an element forming a drawer groove 66 fixed to the side wall of stack 54 enabling individual particulate sorbent material layers to be inserted and removed.

In the vertical orientation as illustrated in FIG. 17c of the '470 Climeworks publication, the particulate sorbent material layer 5 is further equipped with a covering plate 67 on the face of said sorbent material layer 5 facing the inflow gas stream 1 and affixed to the upper portion of said layer. In this manner, a physical barrier is realized which forces air flow through the sorbent material even in the event of compacting of the sorbent material and hole formation. In this manner bypassing can be prevented, maintaining a consistent flow and adsorption behavior.

In FIG. 17b of the '470 Climeworks publication two particle sorbent material layers 5 are shown in horizontal orientation placed on the same level of the stack each with a width Wf half of the width Wf of previous embodiments and held in placed by a supplementary separation wall 68 in addition to the side walls of the stack 54, each wall possessing in this case the same drawer tongue 64 and groove 66 allowing for insertion and removal of individual particulate sorbent material layers 5. The same structure can be placed in the vertical orientation with the corresponding covering plates 67 (as illustrated in c) placed on the face of the particulate sorbent material layer element 5 facing the inlet gas stream 1.

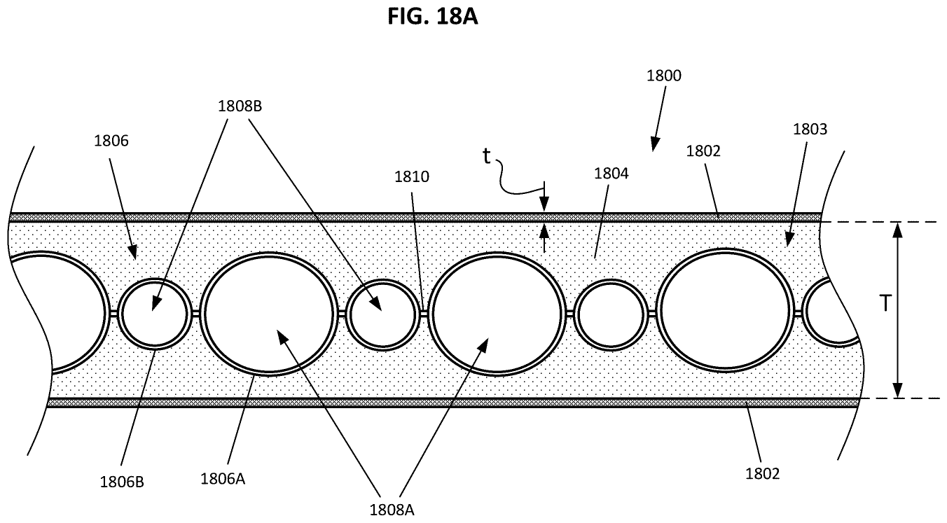

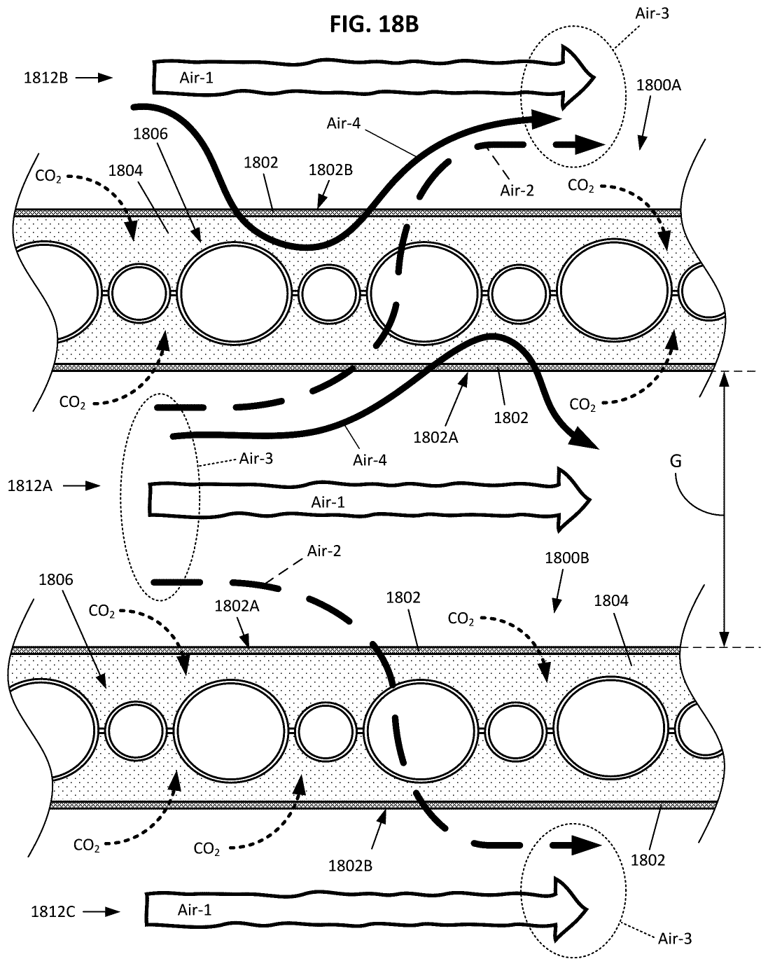

In examples of the present disclosure, a gas separation unit as disclosed herein is used for separation of at least a first gas from a mixture containing the first gas as well as further gases that are different from the first gas by a cyclic adsorption/desorption process. FIGS. 18 through 26 show different examples or components of such gas separation unit, as well as a process of assembling such unit, as further disclosed herein.

FIG. 18A shows an example of a particulate active material construct 1800 according embodiments disclosed herein. The construct 1800 includes two sheets 1802 of flexible fabric material with a specific porosity or permeability such that the fabric material is gas permeable but impermeable to a loose particulate active material 1804. The sheets 1802 of flexible fabric material may be hydrophobic or coated with a hydrophobic material. The construct 1800, or more specifically the loose particulate active material 1804 enclosed therein, is utilized for gas adsorption. Each construct 1800 may be referred to as a “layer” because the construct 1800 has a substantially flat or planar configuration, and in implanting the construct in the gas separation unit, as further disclosed herein, would require at least two layers of such construct 1800 to be arranged in a stack configuration, i.e. stacked on top of each other.

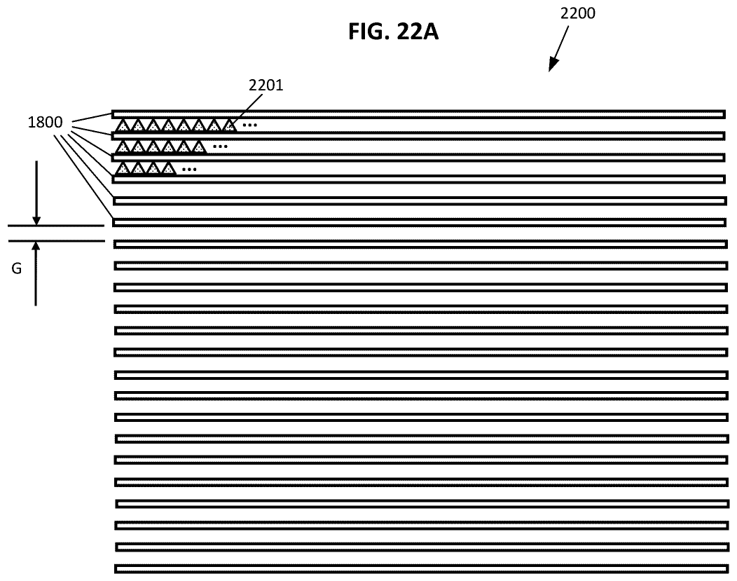

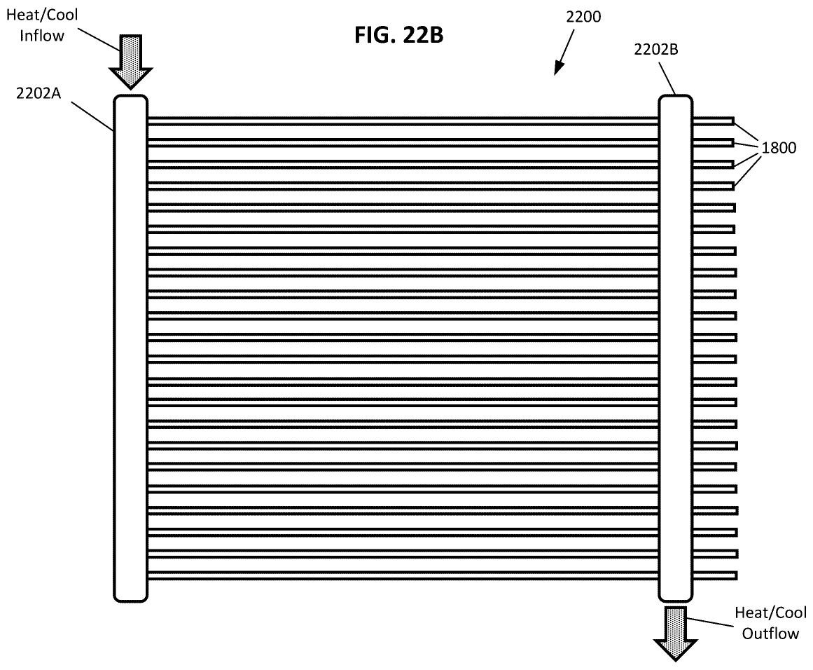

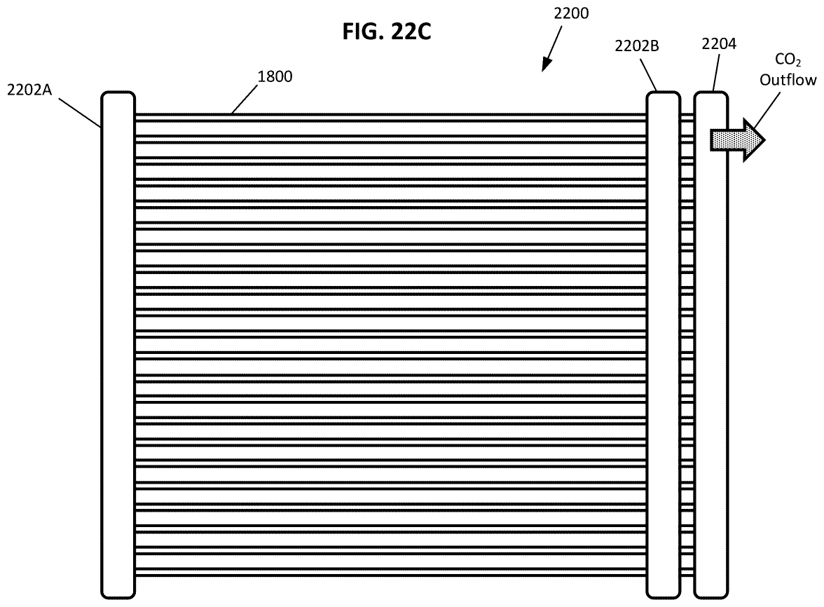

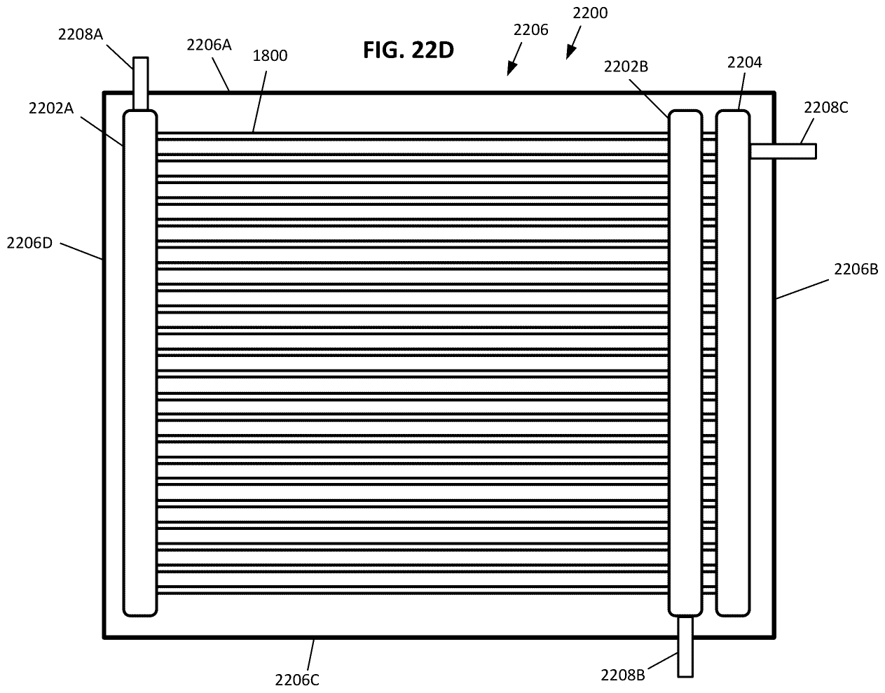

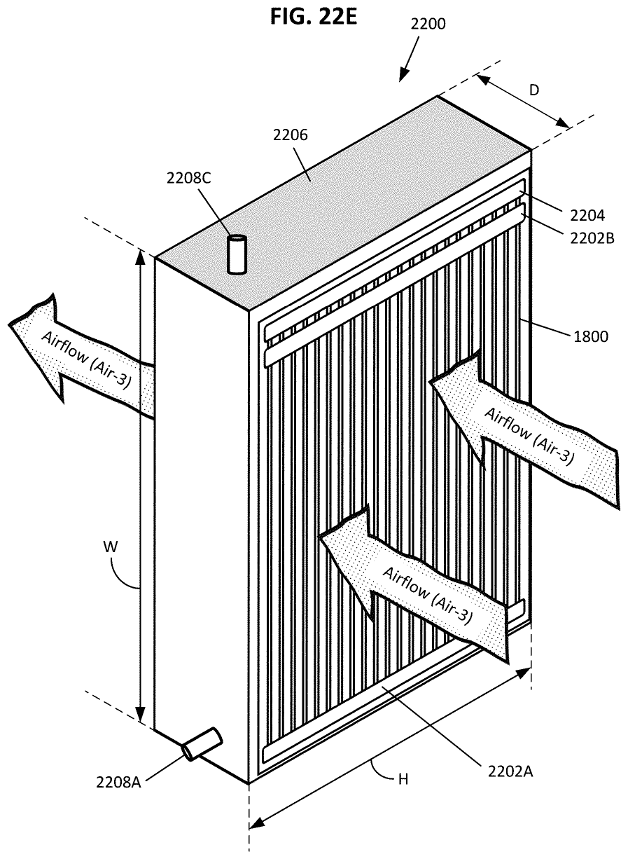

With regard to the porosity of the fabric layer (or the sheets 1802 of flexible fabric material, also referred to as a porous hydrophobic covering), the sheets 1802 may be configured as a very thin membrane (e.g., with a thickness of as small as 0.025 mm) with a high degree of porosity, yet with pore sizes which are small enough to contain the milled active particles (that is, the loose particulate active material 1804). Having a very thin layer is advantageous since carbon dioxide molecules may pass though it both by diffusion as well as air pressure within a gas separation module or unit 2200 as further disclosed herein with respect to FIGS. 22A through 22E. Shorter diffusion pathways offer the benefit of enhancing system performance. Also, hydrophobicity of the materials may beneficially prohibit the entry of liquid water, which could harm the sorbent by creating a phenomenon known as water lock. Water lock occurs when condensed liquid water fills the pores of the sorbent or sorbent carrier materials. While an excess amount of liquid water may be detrimental to adsorption kinetics, a small degree of water or water vapor is desirable, since its evaporation facilitates creating a cooling effect for the sorbent.

In each construct 1800, the sheets 1802 are arranged essentially parallel to each other, defining a first face 1802A of the layer (or construct 1800) and a second face 1802B of the layer (or construct 1800). The first face 1802A may be referred to as an inlet face, and the second face 1802B may be referred to as an outlet face, or vice versa, according to the direction of the airflow passing through the gas separation unit, as further disclosed herein. The sheets 1802 are arranged with a distance between the sheets that is in the range of 1-5 mm. The distance defines a thickness (“T”) as shown in FIG. 18A. The thickness “T” defines the thickness of a cavity 1803 that is formed between the two sheets 1802 in which the loose particulate active material 1804 is located.

With regard to size of active particles (that is, the loose particulate active material 1804), efficiency of the sorbent is directly related to the surface area and the number of binding sites which attract, and temporarily hold, a molecule of carbon dioxide. It is therefore evident that smaller particle sizes, with more exposed surface, are more useful and beneficial in this application. Smaller particles require a fabric layer with a smaller pore size to retain them. Although a smaller particle size is important, ability of carbon dioxide to interact with such particle is also very important. Therefore, implementing a fabric (or membrane) with a multitude of micro-pores is beneficial. The term “microporosity” is commonly used with respect to such materials. These attributes are most commonly found in non-woven materials, and further in expanded non-woven materials.

It is to be understood that the thickness “T” may also approximately define the thickness of the construct 1800, since in some examples as disclosed herein, a thickness (“t”) of each sheet 1802 may be so small, or thin, that the sheet's thickness “t” (e.g., from one side of the sheet to the other side of the same sheet) may be negligible when compared with the greater thickness “T” measured between the two sheets. In some examples, the construct thickness “T” may be inclusively between 1 mm and 5 mm, for example inclusively between 1 mm and 2 mm, between 2 mm and 3 mm, between 3 mm and 4 mm, between 4 mm and 5 mm, or any other range or value therebetween, or combinations thereof. In some examples, the sheet thickness “t” may be inclusively between 1% and 2%, between 2% and 3%, between 3% and 4%, between 4% and 5%, between 5% and 6%, between 6% and 7%, between 7% and 8%, between 8% and 9%, between 9% and 10%, or any other value or range therebetween, or combinations thereof, the value of the construct thickness “T”.

The panel thickness or the thickness “T” of the construct 1800 is important in a system which operates utilizing the method of air flowing along a surface (that is, not being forced through the surface). Specifically, the thickness of the panel or construct 1800, and in turn, the thickness of the sorbent bed, becomes very important. A high number of very thin panels or constructs 1800 is best suited for increased efficiency, since this configuration provides a shorter distance for a carbon dioxide molecule to travel from the passing air stream, across the membrane or sheet 1802, and to the sorbent (loose particulate active material 1804) which temporarily holds the carbon dioxide molecule. Also, in the condition of air flowing past a surface (rather than through) as shown in the flow-through “Air-1” of FIG. 18B, both surfaces or faces 1802A and 1802B of a panel or construct 1800 can be used for adsorption, as opposed to the operational model where air must flow through the panel or construct 1800 as shown in the flow-through “Air-2”, where one surface is dedicated to the entrance of air stream (inlet face) and the opposite surface is dedicated to exiting of the stream (outlet face), and are thus not interchangeable. This difference becomes significant in designing the sorbent panel or construct 1800, since carbon dioxide can enter both surfaces (face 1802A or 1802B) of the panel or construct 1800, and the panel or construct 1800 may include a baffle or barrier layer at the centerline, which may be the series of connected polymeric tubes 1806 (with the connection members 1810). Implementing such internal structure would not be detrimental in the system of the present concept, whereas in the system of the prior-art concept as disclosed in the '470 Climeworks publication, any internal structure will have negative effect on airflow, and therefore, detrimental to system performance.

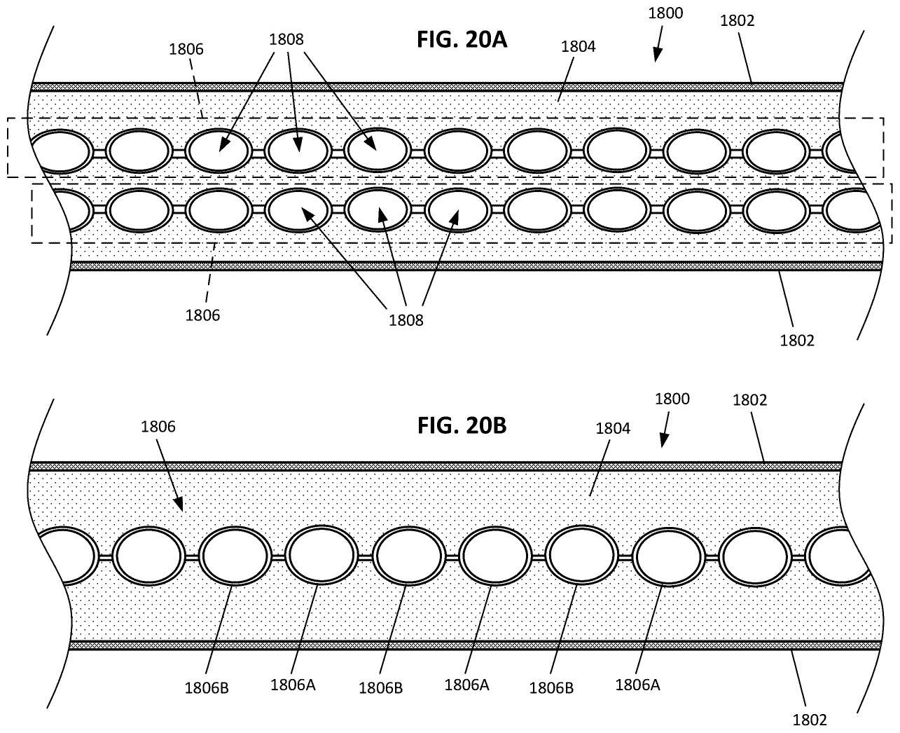

A plurality of microtubes or tubes 1806 may be implemented within the cavity 1803 to be used as heat exchange elements. The tubes 1806 may be disposed inside the construct 1800 such that the tubes 1806 extend along an entire length, or substantially the entire length, of the construct 1800, as further disclosed herein. Each tube 1806 defines a channel 1808 therein. The tubes 1806 may include two types of tubes: a first type 1806A of tubes that define channels 1808A disposed in the cavity 1803 with which desorption is facilitated, and a second type 1806B of tubes that define channels 1808B through which carbon dioxide is configured to exit. Each type of tube may be made of a different material or have a different porosity from the other type of tube to efficiently perform the respective task. For example, the tubes 1806A may be made of a material which allows passage of a heat exchange fluid therethrough and prevents the fluid to permeate into the surrounding active material 1804. For example, the tubes 1806B may be configured with a porosity such that, when carbon dioxide is generated, the generated carbon dioxide would pass from the active material 1804 into the tube 1806B for extraction from the module or unit 2200. As shown in FIG. 18A, the desorbing channels 1808A may be larger (or have a greater cross-sectional area) than the exit channels 1808B, but in some examples, such as the embodiment shown in FIG. 20B, all the tubes 1806 (and/or channels 1808) may be identical or have approximately the same size.

The construct 1800 as shown may have polymeric heat exchange elements in the form of a set of polymeric micro-tubing (that is, the tubes 1806). The tubes 1806 may be fabricated from very thin layers of polymer that are connected together at specific points. The tubes 1806 may be interconnected, and the lumen (channel 1808) of one tube may connect with the lumen of another tube. In some examples, the lumens or channels 1808 of each tube 1806 may be discreet and not interconnected. By connecting polymer layers together to form the tubes 1806, rather than by extrusion, extremely thin walls may be created without regard to needs of concentricity. The extremely thin walls may have a thickness of as little to 0.025 mm and allow for very efficient heat transfer to and from the sorbent. The tubes 1806 may be configured with diameters of inclusively between 0.5 mm and 1.0 mm. In some examples, the tubes 1806 may be configured with an ovular cross-section. These dimensions and geometric variances allow for the creation of a panel (or construct 1800) of sorbent containing heat exchange elements with a very thin cross-section (e.g., with a cross-sectional thickness of as small as 1 mm).

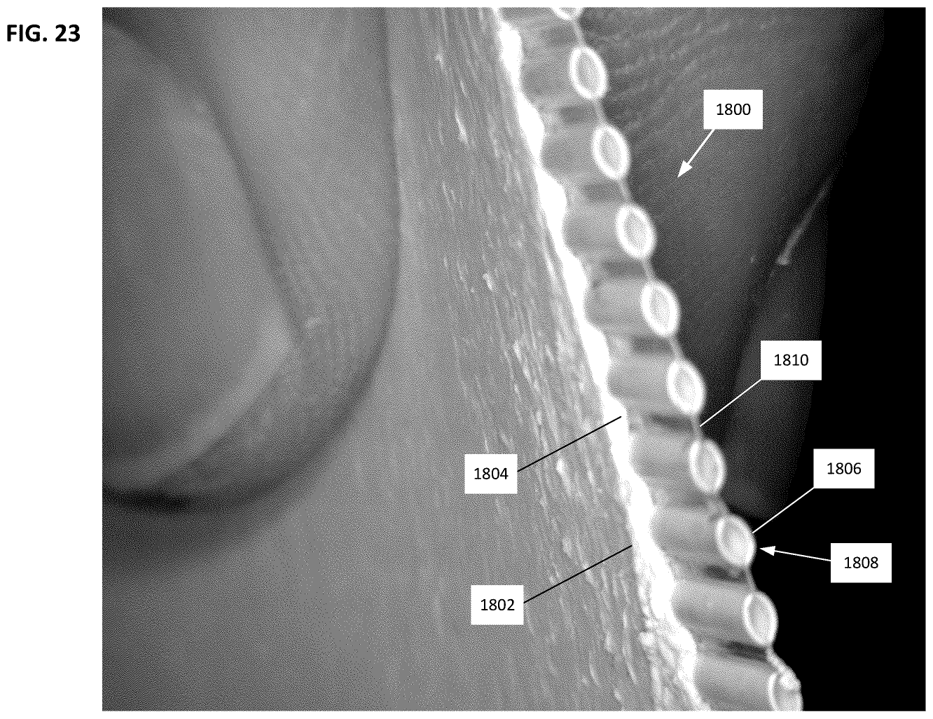

In some examples, the tubes 1806A for receiving the desorbing media may have a different porosity from the tubes 1806B for allowing carbon dioxide to exit from the loose particulate active material 1804. The porosity of the tubes 1806 may vary from being dense to being very porous. In the dense version, the material may not allow either liquid water or water vapor to pass through the walls of the tube 1806. In the porous version, the material may not allow liquid water to pass through, but may allow water vapor to pass. Polymeric heat-exchange tubes (that is, the tubes that receive the desorbing media) 1806A may be configured with some of the tubes having a porous microstructure and some of the tubes having a dense microstructure. Also, the same polymeric heat exchange tubes 1806A may be configured with multiple cross-sectional shapes, sizes, and/or geometries, as suitable. The polymeric heat exchange tubes 1806A may also be provided with a surface treatment, including but not limited to metallization through vapor deposition, for example. The metallized surface may be beneficial in enhancing heat transfer through the tubes 1806B. An example of the embodiment of tubes 1806 as illustrated in FIG. 20B is also shown in FIG. 23.

Referring back to FIG. 18A, at least one connection member or connector 1810 may be formed between the tubes 1806 so as to provide a unitary or interconnected multi-tube construct to be disposed inside the cavity 1803, which may facilitate easier and/or quicker replacement of the tubes 1806 if necessary, since the connection member(s) 1810 allow the tubes 1806 to be replaced and/or reimplemented simultaneously. In some examples, the connection members 1810 are selectively permeable barriers configured to allow airflow therethrough while preventing the loose particulate active material 1804 from passing therethrough.

In some examples, heat exchange fluid or heat transfer fluid may be any suitable desorbing media and may be in a gas, vapor, or liquid form. In some examples, the desorbing media may be water (steam and/or liquid water), salt brine, any suitable glycol-based heat-transfer fluid such as ethylene glycol, a mixture of water and another suitable substance, or any other suitable type of fluid for facilitating heat transfer. Such desorbing media may be provided in the channels 1808A of the tubes 1806A, which may be interspersed between tubes 1806B that are configured to pass carbon dioxide therethrough to provide exit for the carbon dioxide captured within the cavity 1803, for example. The tubes 1806 (both the first type 1806A and the second type 1806B), or at least the non-bent portions thereof, may be arranged essentially parallel to each other, for example using the connection members 1810 as shown.

FIG. 18B shows different airflows which may pass through the construct 1800. The illustration shows two constructs 1800A and 1800B placed in a stacked configuration, where one construct is substantially parallel to another. In the example shown, a first face 1802A of the first construct 1800A faces a corresponding first face 1802A of the second construct 1800B. Channels 1812 are formed between the constructs 1800 to allow air flow between the adjacent constructs, as shown. The channel 1812A is defined between the constructs 1800A and 1800B, and two additional channels 1812B and 1812C are formed on the other sides of the constructs 1800A and 1800B, respectively. These channels 1812A and 1812C may be formed between the shown constructs 1800 and additional constructs 1800 that are not illustrated, for simplicity. Each channel 1812 is configured to allow flow-through of air (“Air-1”, shown in white arrows with black outlines). For example, the layers or constructs 1800 are arranged such that inlet faces 1802A of adjacent layers or constructs 1800 are facing each other and enclose gas inlet channels (e.g., 1812A), and such that outlet faces 1802B are facing each other and enclose gas outlet channels (e.g., 1812B, 1812C), as shown, although it is to be understood that the outlet faces 1802B may in some examples function as inlet faces 1802A, and vice versa. The channels 1812 are each defined by a gap “G” formed between the adjacent faces 1802A or 1802B, which may be uniform throughout or vary in distance from one gap to another. In some examples, a mean distance (that is, an average distance of the gaps “G”) between the faces 1802A or 1802B defining said channels 1812, measured in a direction essentially perpendicular to a main gas inflow direction and a main gas outflow direction, respectively, is in the range of inclusively between 0.1 cm and 15 cm. In some examples, the range may be inclusively between 0.1 cm and 0.2 cm, 0.2 cm and 0.3 cm, 0.3 cm and 0.4 cm, 0.4 cm and 0.5 cm, 0.5 cm and 1 cm, 1 cm and 2 cm, 2 cm and 3 cm, 3 cm and 4 cm, 4 cm and 5 cm, 5 cm and 10 cm, 10 cm and 15 cm, or any other suitable value or range therebetween, or combination thereof.

The air gaps “G” between the panels or constructs 1800 may be configured based on a multitude of variables including overall length of the panel or construct 1800, operating parameters of cycle time of the system in which the constructs 1800 are implemented, and energy usage versus system efficiency calculations, for example. Normally, it is desirable to maximize the given volume of the module or reactor portion of the system (that is, the gas separation module or unit 2200). Space must be dedicated to: 1) the sorbent material itself, 2) any supporting structures, and 3) space for air to flow past the panels. In many cases, the space is maintained using spacers 2201 such as those shown in FIG. 22A, for example. Without inhibiting airflow, material of the spacers 2201 is configured to hold the panels securely for cyclic operation and is made from any suitable microporous material, including but not limited to metal and/or polymer such as polyethylene (PE) or polytetrafluoroethylene (PTFE), for example, which can withstand operating parameters of airspeed and temperature extremes. In some examples, a corrugated and expanded aluminum or aluminum mesh may be implemented as the spacers 2201. This mesh can also be inserted into a panel itself (e.g., internal to the construct 1800), then corrugated, thereby maximizing the amount of sorbent in the volume of the module or unit 2200 by configuring it not only as the panels or constructs 1800, but also as the spacers of the panels or constructs 1800.

Each of the first faces 1802A defines an inlet face of the corresponding layer or construct. The first faces 1802A in this example may be referred to as “inlet faces” due to the flow-through (“Air-2”, shown in broken, bold arrows) being able to pass through these first faces 1802A to enter the cavity 1803 holding the loose particulate active material 1804 and the tubes 1806 of each construct 1800. However, as explained herein, the same inlet face may also be utilized as an outlet face for a different flow-through of air and thus is not limited to only providing a unidirectional flow therethrough. As such, all faces 1802A and 1802B as disclosed herein are bidirectional and interchangeable between being an inlet and an outlet for the flow-throughs with differing directionalities.

Flow-through of gas mixture in this context is generally to be understood as flowing along the parallel fluid passages and parallel to the sorbent layers (e.g., constructs 1800) to allow for adsorption of the carbon dioxide on said sorbent layers. In general, a flow-through includes at least three types of flow as shown in FIG. 18B. The first type (e.g., flow-through shown as “Air-1”) is a flow-through that travels parallel to a surface of a structure, such as a sorbent layer or adsorber element (that is, the construct 1800), and may include a flow running through a space between two structures, such as two sorbent layers (e.g., the channel 1812 between the constructs 1800) or opposing walls of a channel (e.g., the opposing inlet faces 1802A or outlet faces 1802B). The second type (e.g., flow-through shown as “Air-2”) is a flow-through that travels through into a surface and through the material such as that of a porous sorbent layer that is supported by the surface (e.g., through the loose particulate active material 1804), allowing the air to diffuse out of a surface on the other side of the structure. The first type of flow-through may change into the second type of flow-through after traveling through the material, and vice versa. The third type (e.g., flow-through shown as “Air-3”, which is also shown in FIG. 22E) is a flow-through representing a total movement of a mass of gas mixture which travels through a structure (e.g., the gas separation unit 2200 of FIG. 22E in which the constructs 1800 are installed) over a given time, which may include one or both of the first and/or second types of flow-through (a combination of different flow-throughs “Air-1” and “Air-2” as shown by the dotted circles of FIG. 18B) as explained above. Therefore, the gas inflow into the gas separation unit 2200 may pass parallel to the inlet face 1802A or outlet face 1802B (as in the flow-through “Air-1”), or the gas inflow may pass through the inlet face 1802A, subsequently through the loose particulate active material 1804 located in the cavity 1803 of the respective layer or construct 1800, and subsequently to exit the respective layer through the outlet face 1802B to form the gas outflow (as in the flow-through “Air-2”). The gas outflow from the flow-through “Air-2” may fuse with another gas inflow that passes parallel to the outlet face 1802B, that is, another flow-through “Air-1”, to form the flow-through “Air-3” as shown in channels 1812B and 1812C of the figure. In some examples, another flow-through “Air-4” may be present, where the flow-through “Air-4” enters an inlet face 1802A or outlet face 1802B and subsequently exits from the same face from which it entered (e.g., enter and leave from the inlet face 1802A or enter and leave from the outlet face 1802B) such that any of the faces 1802A and 1802B can function as the inlet and outlet faces. In such examples, the flow-through “Air-3” may be a combination of any two or more of the flow-throughs “Air-1”, “Air-2”, and “Air-4”.

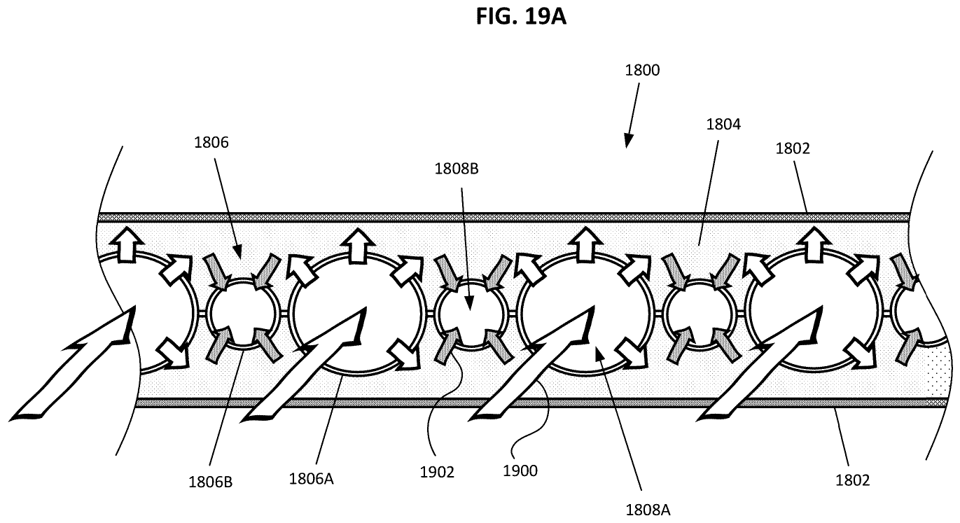

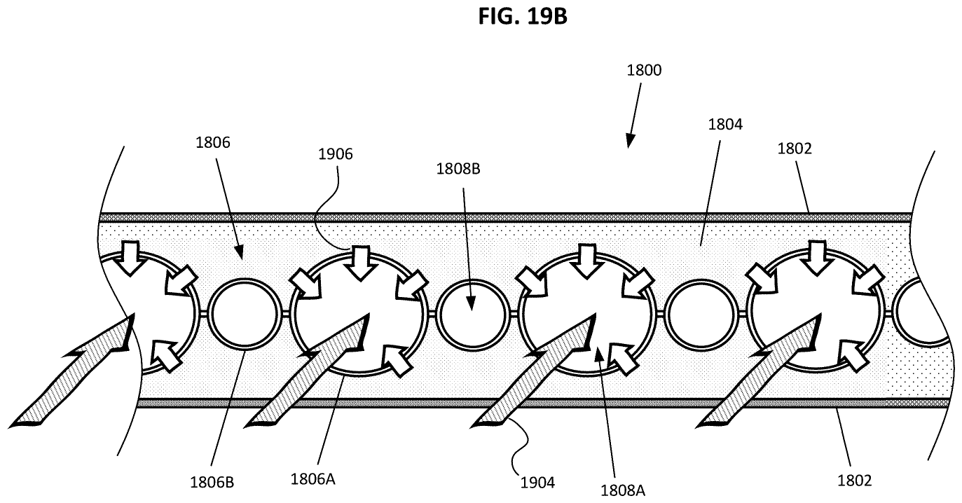

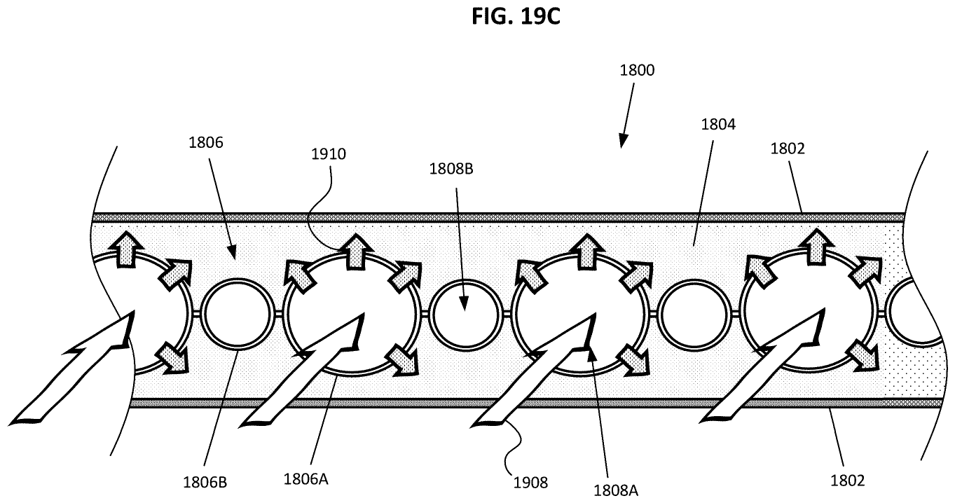

FIG. 19A shows the directions of fluid flow during a desorption step of the gas separation process. As shown by white arrows 1900, desorbing media flows from the manifold (e.g., manifold 2202A as further disclosed herein) into the channels 1808A of the tubes 1806A made to receive the desorbing media (longer white arrows), after which the desorbing media flows into the cavity 1803 holding the loose particulate active material 1804 (shorter white arrows). As shown by shaded arrows 1902, carbon dioxide, subsequently or simultaneously with the desorbing media flow 1900, flows from the loose particulate active material 1804 into the channels 1808B of the tubes 1806B made to receive the carbon dioxide. Specifically, when the active material 1804 reaches a certain elevated temperature, carbon dioxide therein is released and passes into the carbon dioxide capturing tube 1806B within the panel or construct 1800. The tube 1806B, or more specifically the channel 1808B within the tube, may be under vacuum during this step. Also, the entire module or unit 2200 may be under partial vacuum to reduce the amount of oxygen present during the desorption step, which may beneficially mitigate undesired oxidation degradation of the sorbent chemistry.

FIG. 19B shows the directions of heat flow during a cooling step of the gas separation process. As shown by shaded arrows 1904, cooling liquid such as water flows into the channels 1808A, which also draws heat from the surrounding loose particulate active material 1804 into the channels 1808A as shown by white arrows 1906. Applying the cooling step is optional but beneficially allows the adsorption process to being sooner than when the active material 1804 is allowed to cool via passive cooling.

FIG. 19C shows the directions of pressure flow during a pressurization step of the gas separation process. As shown by white arrows 1908, pressurizing fluid, which may be water in either liquid or vapor form as well as any other suitable fluid, flows into the channels 1808A, which increases the internal pressure within the channels 1808A, and the internal pressure flows outwardly from the channels 1808A toward the loose particulate active material 1804 as shown by shaded arrows 1910. The pressurization step is optional but may beneficially enhance a stiffness of the panel or construct 1800 during the adsorption process. The tubes 1806A may be pressurized, and columns of pressurized air may be used to provide structural integrity for the construct 1800, similar to how an air mattress, an inflatable kayak, or an inflatable bounce house operates.

FIGS. 20A and 20B show different examples of tube configurations in the construct 1800 as disclosed herein. The tubes 1806 may have differently sized tubes 1806A and 1806B (and therefore differently sized channels 1808A and 1808B) as shown in FIGS. 19A through 19C, or substantially similarly sized tubes 1806A and 1806B as shown in FIGS. 20A and 20B. There may also be two or more layered or stacked tubes 1806 as shown in FIG. 20A. The stacked tubes (or sets of tubes) may be positioned substantially parallel to each other.

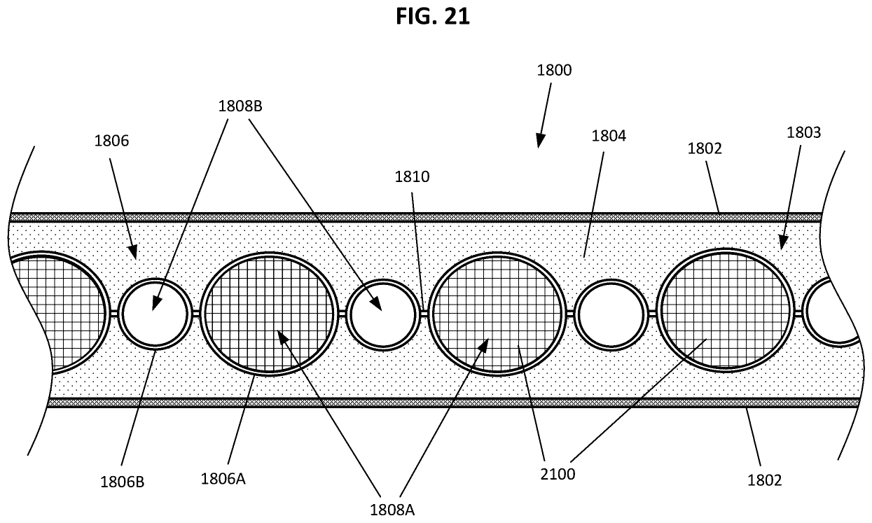

FIG. 21 shows an example of the construct 1800 in which a portion of the tubes 1806 have conductor components 2100 extending through and filling their channels 1808. In the example shown, the conductor components 2100, which may include elongate components of conductive metal or any other suitable conductive material including but not limited to chromium-cobalt (CrCo) alloys, nickel-chromium (NiCr) or nickel-iron-chromium (NiFeCr) alloys such as nichrome (e.g., nichrome 80/20), iron-chromium-aluminum (FeCrAl) alloys, and/or copper-nickel (CuNi) alloys, for example, extend through and fill the channels 1808A that were formed to receive desorbing media. Therefore, instead of the desorbing media, the channels 1808A instead receive the conductor components 2100 which facilitate controlling the temperature within by electrically generating heat therethrough.

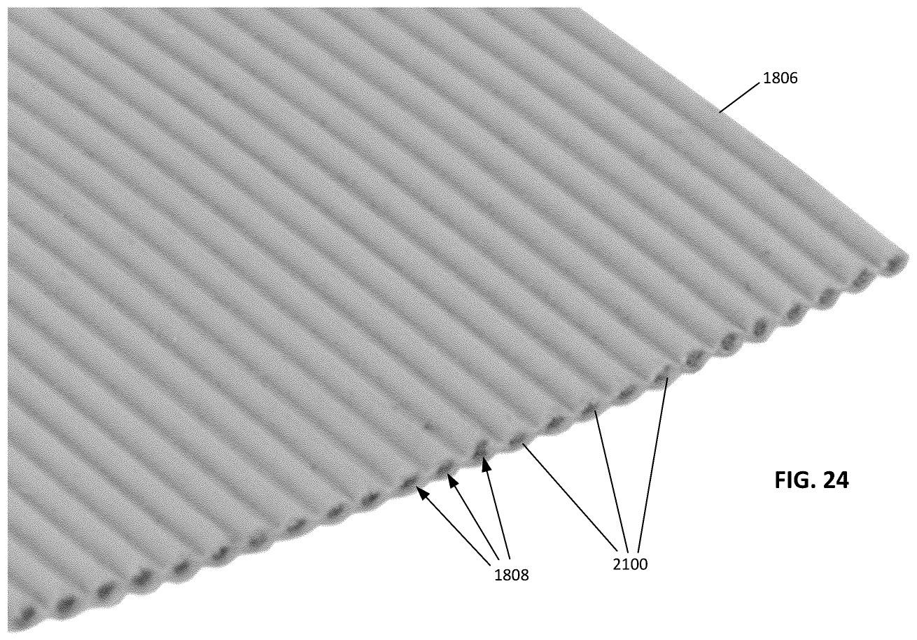

Generally known as electrical resistance heating, a conductor material is chosen which has a relatively high degree of electrical resistivity (p) such that the resulting conductor component has a relatively high degree of electrical resistance (R), where R=ρL/A (L is the length of the conductor component, and A is the cross-sectional area of the conductor component). Electrical current passing through the conductor component causes the conductor to emit heat. This type of heating may be commonly found in electrical heating elements (such as kitchen toasters, for instance). In some examples, the resistivity (p) of the material at room temperature (20° C.) may be inclusively between 1.00×10⁻⁶ Ωm and 1.20×10⁻⁶ Ωm, 1.20×10⁻⁶ Ωm and 1.50×10⁻⁶ (2m, 1.50×10⁻⁶ Ωm and 1.70×10⁻⁶ Ωm, 1.70×10⁻⁶ Ωm and 2.00×10⁻⁶ Ωm, or any other suitable range or value therebetween, or combination thereof. The channels 1808B can still receive the carbon dioxide that exits from the surrounding loose particulate active material 1804 as explained above. An example of the embodiment of tubes 1806 with the conductor components 2100 installed therein, as illustrated in FIG. 21, is also shown in FIG. 24.

FIGS. 22A through 22D show the steps in the process of creating, forming, or manufacturing a gas separation unit 2200 as disclosed herein. In FIG. 22A, a plurality of the layers or constructs 1800 as described above are positioned in a substantially parallel configuration with respect to each other, separated by a gap “G” as shown. The gap “G” may be maintained using a plurality of spacers 2201 which may be suitably shaped to prevent relative movement of the constructs 1800. The spacers 2201 may be formed as a corrugated material, which may comprise of a sorbent material, and extend along at least a portion of the length of the construct 1800 between adjacent constructs 1800.

In FIG. 22B, a gas inlet side or gas inlet manifold (also referred to as a first manifold) 2202A is installed at or near one end of the constructs 1800 such that the manifold 2202A is coupled to all the constructs 1800. A desorbing media outlet manifold (also referred to as a second manifold) 2202B is installed at or near an opposing end of the constructs 1800. The manifold 2202A facilitates inflow of fluid for heating or cooling the channels 1808 of the constructs, while the manifold 2202B facilitates outflow of such fluid.

In FIG. 22C, a carbon dioxide collection manifold (also referred to as a third manifold) 2204 is installed at or near the opposing end of the constructs 1800 proximal to the manifold 2202B. The manifold 2204 facilitates collection of carbon dioxide that exits from the constructs 1800 as explained above. As such, in view of the above, the manifold 2202A is fluidly coupled with the channels 1808A for desorbing media inflow, the manifold 2202B is fluidly coupled with the channels 1808A for desorbing media outflow, and the manifold 2204 is fluidly coupled with the channels 1808B for carbon dioxide collection and outflow. In some examples, the manifolds 2202A and 2202B are electrically coupled with the conductor components 2100 such that electricity may be passed from one manifold to another, thereby generating heat.

In FIG. 22D, the constructs 1800 as well as the manifolds 2202A, 2202B, and 2204 are installed inside a housing 2206, or in some examples, the constructs 1800 are slidably and removably held in place in the housing 2206, which may be an external frame formed using the manifolds 2202A, 2202B, and 2204. There are also ports 2208 in the housing 2206 to facilitate inflow or outflow of the respective fluids as explained above. For example, port 2208A is for the inflow of desorbing media, port 2208B is for the outflow of desorbing media, and port 2208C is for the outflow of carbon dioxide from the unit 2200 as shown. The manifolds may be formed such that the desorbing media enters and exits the unit 2200 and in such a way that the flow of the desorbing media that is confined within the unit 2200 would pass through at least one of the layers or constructs 1800.

In some examples, the layers or constructs 1800 are held in place in the housing 2206 by at least a pair of side walls (for example side walls 2206A and 2206C forming a pair and wide walls 2206B and 2206D forming another pair as shown) which are either arranged pairwise vertically or pairwise horizontally, and on which side walls elements (that is, the side wall elements 2206A through 2206D which define these side walls) are provided, which allow individual layers or constructs 1800 to be shifted into and/or out of the housing 2206 in a replaceable manner.

FIG. 22E shows an example of the completed unit 2200 as implemented to facilitate gas separation, provided as a module for ease of handling, shipping, and maintenance. As shown, the airflow into and out of the unit 2200 are illustrated using shaded arrows, which are the flow-throughs “Air-3” as previously discussed. The carbon dioxide within the airflow may be captured by the unit 2200 and released via the port 2208C. Each construct 1800 is also shown to have a width “W” and a depth “D” which substantially define the dimensions of the overall unit 2200, and the height “H” of the unit 2200 depends on the number of constructs 1800 that are installed as well as the distance of each gap “G” therebetween. In some examples, the housing 2206 may be formed with additional manifolds, for example a manifold on an inlet side (where the airflow enters the unit 2200) and another manifold on an outlet side (where the airflow exits the unit 2200) defining a pathway for the gas or airflow therebetween to be confined in the unit and pass through the layers or constructs 1800 as shown. In some examples, the total frame depth “D” is in the range of inclusively between 0.5 m and 1.8 m (or between 0.5 m and 0.7 m, 0.7 m and 1 m, 1 m and 1.3 m, 1.3 m and 1.5 m, 1.5 m and 1.8 m, or any other value or range therebetween or combination thereof), and the frame width “W” is in the range of inclusively between 0.5 m and 1.9 m (or between 0.5 m and 0.7 m, 0.7 m and 1 m, 1 m and 1.3 m, 1.3 m and 1.5 m, 1.5 m and 1.7 m, 1.7 m and 1.9 m, or any other value or range therebetween or combination thereof).

Examples of how the gas separation unit or module 2200 may be used in operation for gas separation are explained herein. As shown by the arrows of FIG. 22E, airflow passes through the panels, which are the constructs 1800 that are held in place by the frame(s) of the housing 2206. Specifically, air enters the unit or module 2200 and flows through the sheets 1802 of flexible fabric material and into the panel or construct 1800. As the air flows through the panel or construct 1800, the air would pass over the active particles or loose particulate active material 1804 as well as pass over the heat exchange elements, e.g. the tubes 1806. Carbon dioxide is adsorbed onto the active particles 1804 during the adsorption step and released from the active particles 1804 when heated, at the desorption step. Air (and/or carbon dioxide) passes through the sheets 1802 of flexible fabric material on the outlet side of the panel or construct 1800. In some examples, the construct 1800 may be described as a thinly packed bed configuration with heat exchange elements housed within the packed bed.

In some examples, by miniaturizing various features, the unit 2200 may be configured such that air is not required to flow through the sorbent bed (the loose particulate active material 1804). The air may instead flow along the surface of the layers 1802 of flexible fabric material from inlet to outlet of the unit or module 2200, as shown in the flow-through “Air-1” of FIG. 18B. Such configuration may improve efficiency of the unit or module 2200, as well as the system in which the unit or module 2200 is implemented, by increasing an amount of sorbent within the given volume of the unit or module 2200 while also lowering the pressure delta form inlet to outlet of the unit or module 2200. Lowering pressure may be beneficial in lowering the amount of energy needed to apply a force to the air in order to cause the air to pass through the unit or module 2200 (e.g., using an electrically activated fan).

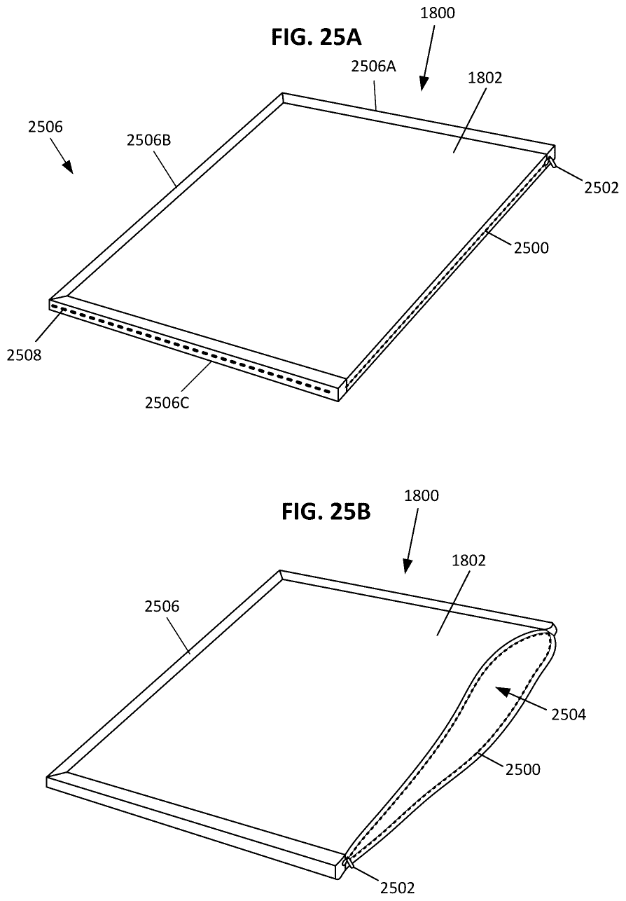

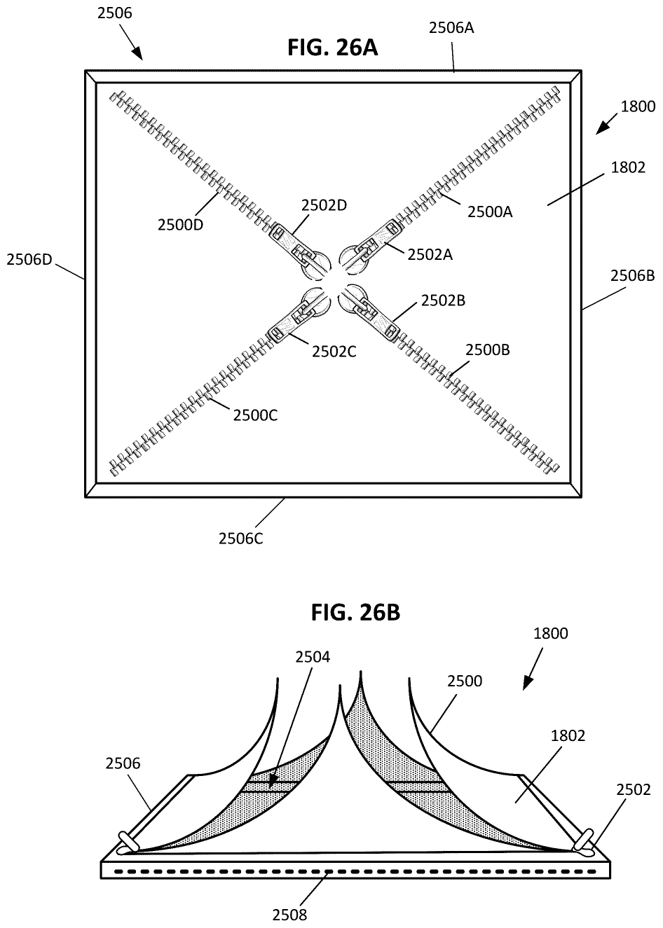

FIGS. 25A and 25B show an example of the construct 1800 being mounted on a frame structure 2506 according to embodiments disclosed herein. The frame structure 2506 may be a stiff frame structure such as a manifold structure, or a stiff rectangular circumferential frame structure as shown. However, it is to be understood that the frame structure 2506 may be any other suitable shape (for example, circular, ovular, polygonal, curved, etc.) and configuration (for example, any suitable number of component or components forming the frame structure, such that the frame structure may be unitarily formed or assembled from multiple components) that is sufficiently stiff to hold the layer or construct 1800. In some examples, the frame structure 2506 includes at least three metal profiles arranged with a pair of metal profiles that is mutually parallel, and the metal profiles have at least a pair of legs that are arranged essentially parallel to the inlet face of the construct 1800 and the outlet face of the construct 1800 and allow for fixing the sheets 1802 of flexible fabric material circumferentially to the legs on each respective face. That is, the frame structure 2506 may have at least a first leg 2506A, a second leg 2506B, and a third leg 2506C as shown, where the first leg 2506A and the third leg 2506C are mutually parallel. The example with four legs (2506A through 2506D) is shown in FIGS. 26A and 26B.

Referring back to FIGS. 25A and 25B, the legs 2506A through 2506C are disposed circumferentially or at the periphery of the construct 1800 to hold the sheets 1802 of flexible fabric material in place. In some examples, an integral resealable feature 2500 may be located between the two layers of the flexible fabric material (e.g., between 1802A and 1802B) such as a zipper, as well as a control mechanism 2502 such as a fastener to open and close the resealable feature 2500. Opening the resealable feature 2500 forms an access opening 2504 which allows for the loose particulate active material 1804 and/or the tubes 1806 inside to be removed or replaced/refilled as suitable. In some examples, the tubes 1806, or at least the non-bent portions thereof, are arranged essentially parallel to at least one pair of the mutually parallel metal profiles (that is, legs 2506A and 2506C in the example shown in FIGS. 25A and 25B, and/or legs 2506B and 2506D in the example shown in FIGS. 26A and 26B). In some examples, the metal profiles are in thermal contact with a plurality of sheets of metal (not shown) which are arranged essentially perpendicular to a main plane of the frame structure 2600 and perpendicular to the tubes 1806, and extend in a continuous manner between the pair of mutually parallel metal profiles or legs 2506. In some examples, the parallel profiles such as the legs 2506A and 2506C are provided with a plurality of holes 2508 through which the plurality of tubes 1806 penetrate. The holes 2508 allow the channels 1808 within the tubes 1806 to be fluidly coupled with the appropriate manifolds as explained above with respect to FIGS. 22A through 22E.

FIGS. 26A and 26B illustrate another example of how the resealable feature 2500 and the control mechanism 2502 may be configured according to embodiments disclosed herein. In the example shown, the resealable feature 2500 includes four separately operable resealable features 2500A through 2500D shaped in an X-shaped configuration extending from a corner toward a center of the frame structure 2506 or the construct 1800. The features 2500A through 2500D each has its own control mechanism (2502A through 2502D, respectively) and are disposed on one of the two layers 1802 such that operating the suitable control mechanism 2502 would form the opening 2504. It is to be understood that any suitable shape and configuration of the resealable feature 2500 and control mechanisms 2502 other than the X-shaped configuration as shown, may be implemented.

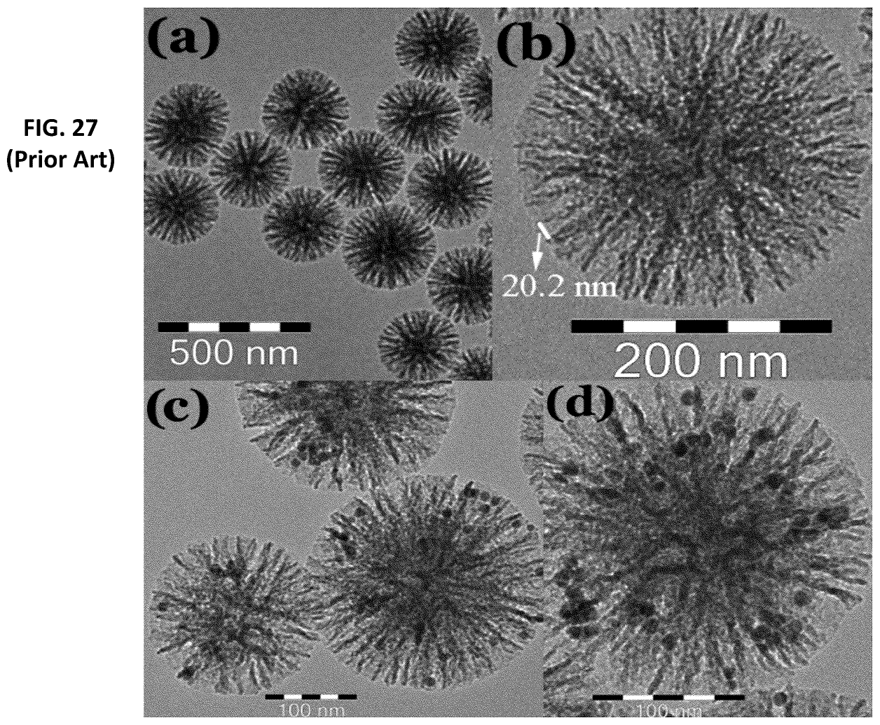

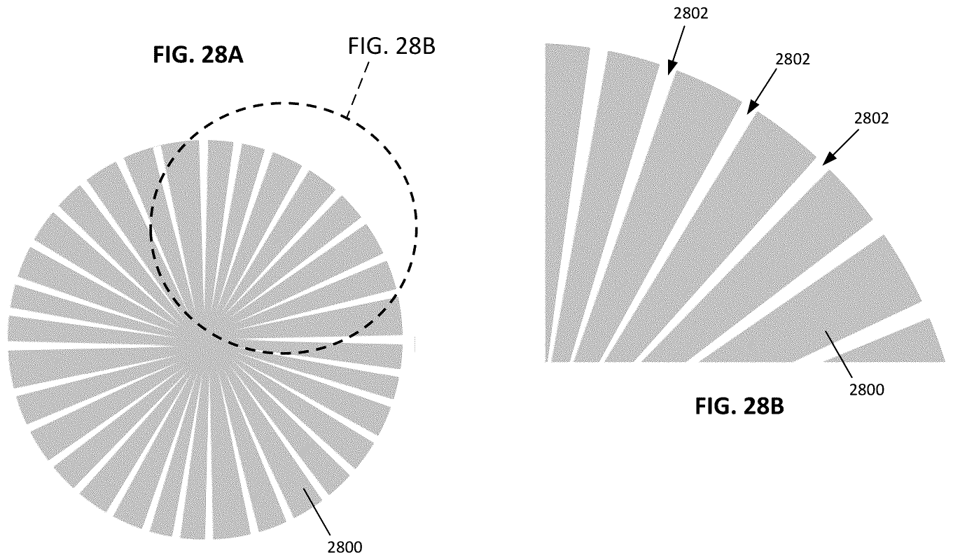

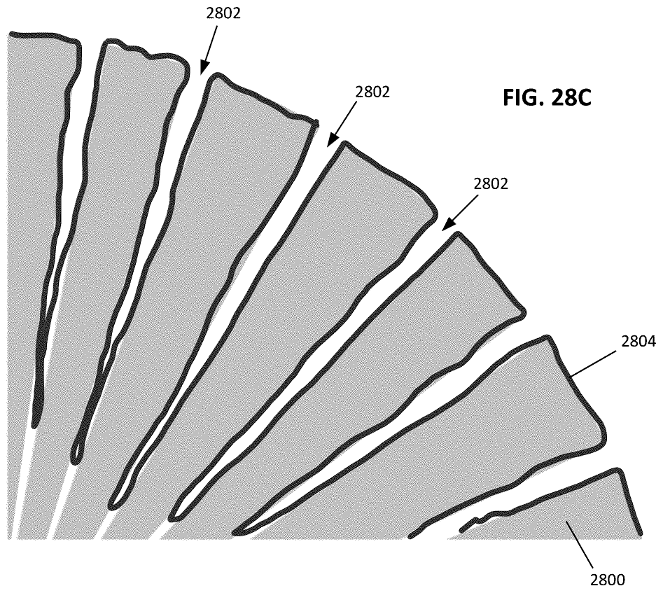

FIG. 27 shows examples of transmission electron microscopes (TEM) images of particulate materials (obtained from Shokouhimehr et al. “Magnetically Separable and Sustainable Nanostructured Catalysts for Heterogeneous Reduction of Nitroaromatics” Catalysts 2015, 5, 534-560; doi:10.3390/catal5020534). Specifically, the images (a) and (b) show loose particulates of mesoporous silica nanospheres (KCC-1) while the images (c) and (d) show loose particulates of magnetic nanoparticles-supported palladium (Ni@Pd)/KCC-1 nanocatalysts. Such particulates are some of the examples of inactive material as known in the art. The inactive material may be treated to form active material, using methods as disclosed with respect to FIGS. 28A through 28C as follow.

FIGS. 28A and 28B show a cross-sectional diagram of a single inactive particle 2800, such as mesoporous silica, in which the particle has a generally spherical shape with a plurality of pores 2802 as shown, extending from an outer periphery of the particle 2800 into and toward the center thereof. The pores 2802 increase the porosity or permeability as well as a surface area of the particle 2800. FIG. 28C shows the particle 2800 with a soluble sorbent material coating 2804 applied to an external surface thereof so as to cover the surface area of the particle 2800 with a layer of the soluble sorbent material coating 2804. In some examples, the soluble sorbent material coating 2804 may include, but is not limited to, any suitable polymeric coatings such as polyethylenimine (PEI) or the like, as known in the art.

In some examples, the coating 2804 is applied without substantially filling or obstructing the pores 2802. In some examples, the coating 2804 is applied without decreasing the surface area of the particle 2800 by more than 20%. For example, a second surface area of the particle 2800 with the coating 2804 applied is at least 80% of a first surface area of the particle 2800 without the coating 2804. In some examples, the second surface area may be at least 85%, at least 90%, at least 95%, or any other value or range therebetween, as compared to the first surface area. In some examples, a second porosity or permeability of the particle 2800 with the coating 2804 applied is at least 80% of a first porosity or permeability of the particle 2800 without the coating 2804. In some examples, the second porosity or permeability may be at least 85%, at least 90%, or any other value or combination of ranges therebetween, as compared to the first porosity or permeability. With the coating 2804 applied to the surface, the particle 2800 made of an inactive material can be beneficially implemented as the active particle 1804 as disclosed herein. Beneficially, this coating technique allows for a wider variety of materials to be implemented for carbon capture, as suitable, while minimally compromising the porosity or permeability of the original material that is being used. A non-exhaustive list of possible inactive materials that may be used to form the active particle using such process includes: fumed alumina, metalorganic framework (MOF), and mesoporous materials which may include silica and alumina that have similarly-sized mesopores, including but not limited to mesoporous carbon and mesoporous oxides of niobium, tantalum, titanium, zirconium, cerium and tin, for example. Mesoporous carbon has porosity within the mesopore range which beneficially increases the effective surface area significantly. In some examples, the mesoporous material may be activated carbon which may be composed of a carbon framework with both mesoporosity and microporosity, depending on the conditions under which it was synthesized.

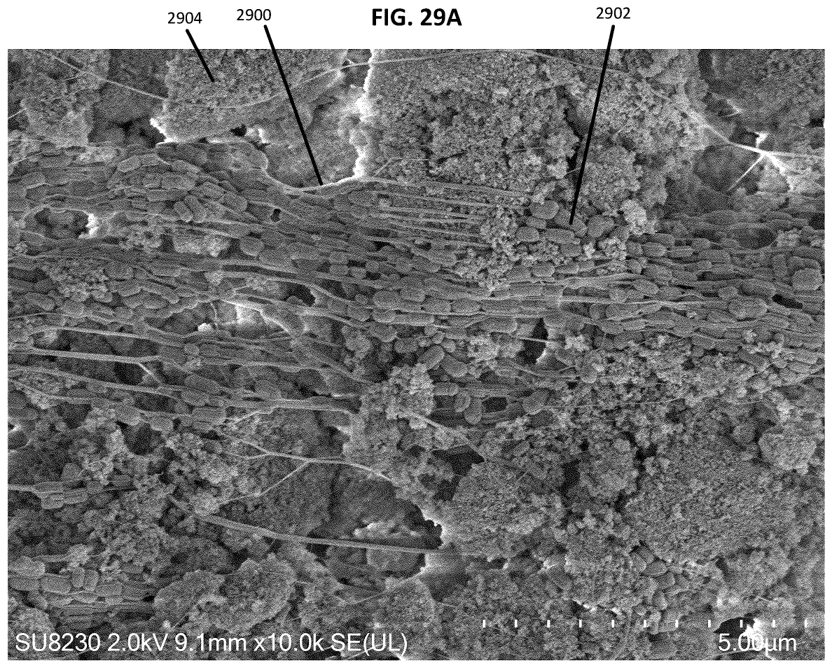

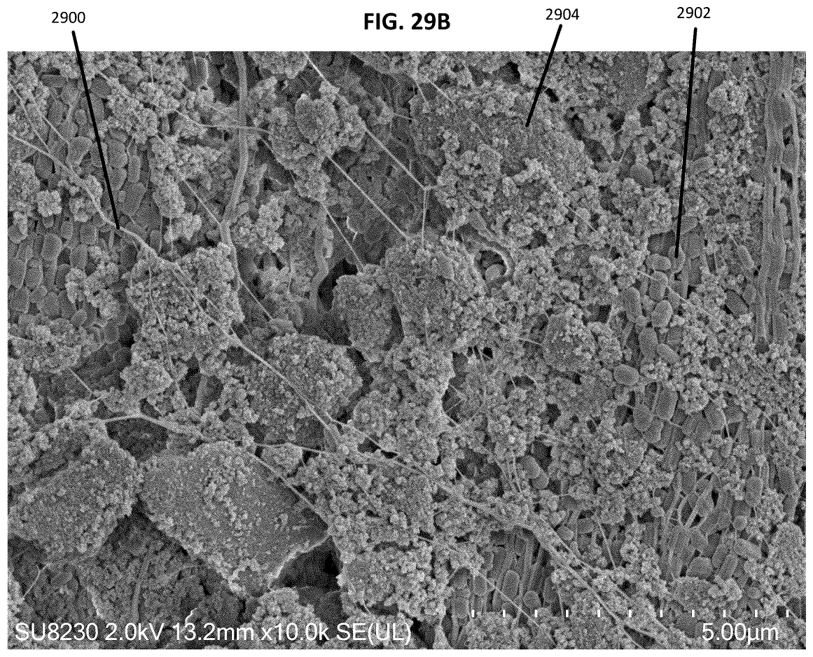

FIG. 29A is an SEM image of a surface of an inactive material that is formed using inactive particles before coating, and FIG. 29B is an SEM image of a surface of an active material that is formed by coating the inactive material of FIG. 29A using the soluble sorbent material coating (e.g., PEI) as explained above, with a scale showing the length of 5.00 μm relative to the image (such that a distance between two consecutive vertical markers represents 0.5 μm). Indicated at the bottom of the images are: “SU8230 2.0 kV 9.1 mm×10.0k SE(UL)” for FIG. 29A, and “SU8230 2.0 kV 13.2 mm×10.0k SE(UL)” for FIG. 29B. The surface in each image includes a plurality of strand-like structures 2900, oblong pill-shaped structures 2902, and irregularly shaped structures 2904 having comparatively rough or “crusty-looking” surfaces. In some examples, the strand-like structures 2900 are the individual fibrils of PTFE or ePTFE, the oblong structures 2902 are the individual nodes of PTFE or ePTFE, and the structures 2904 with the rough surfaces are the agglomerated silica particles.

The surface area of such particles (for example, particles 1804 and 2800) can be measured using any suitable equipment implementing the Brunauer, Emmett, and Teller (BET) theory which is used to measure the surface area of solid or porous materials, as known in the art. Examples of such equipment to generate BET data include, but are not limited to, an AutoSorb iQ instrument (for example, chemisorption/physisorption analyzer) from Anton-Paar (Graz, Austria). In some examples, the uncoated surface (FIG. 29A) of the material may have a BET surface area of about 185 m²/(g of sorbent), whereas the same material after the coating is applied (FIG. 29B) may have a BET surface area of about 72 m²/(gram of sorbent). As such, in some examples, the application of the coating may reduce the BET surface area by from about 55% to 60%, 60% to 65%, 65% to 70%, or any other suitable combination of ranges or value therebetween.

Additional measurements may be performed or calculated with respect to samples of the porous particles or porous materials disclosed herein, as suitable. In some examples, a “bulk density” may be calculated by simply dividing the mass of the porous sample by its total volume (e.g., total volume of the porous sample being the volume of solid content added to the volume of void content). In some examples, a “true density” may be determined using a helium pycnometer (or any other suitable gas pycnometer as known in the art) which measures the volume of only the solid content in the porous sample using Boyle's Law which is known as “true volume.” Since the mass of the sample is known, the true density may be obtained by dividing the mass of the sample by its true volume. In some examples, a porosity may be calculated to define the measurement of the void content in the porous material, where a “percentage porosity” may be calculated using the below equation:

$$\% Porosity = ( 1 - \frac{B}{T} ) * 100 \qquad ( Equation 1 )$$

where B is the bulk density and T is the true density of the porous material.

In some examples, a “Gurley”, which is a measurement of the resistance of the porous sample to airflow under a given pressure drop, may be determined. Gurley is defined as the time in seconds that it takes for 100 cm³ of air to pass through one square inch of membrane when a constant pressure of 4.88 inches of water (0.177 psi) is applied. A higher Gurley number indicates lower air permeability or greater resistance to airflow under a given pressure drop. Gurley is reported in units of seconds or (s/(100 cm³*in²)) at 0.177 psi.

Differences between a sample before and after the aforementioned coating (e.g., PEI coating) is applied may be observed by determining the aforementioned measurements and comparing them in a table (Table 1) similar to the one shown below:

TABLE 1
Comparison of measurements before and after coating a material

| | Sample | Sample |
|---|---|---|
| Material Property | before coating | after coating |
| Density (g/cm³) | 0.3582 | 0.5144 |
| Gurley (sec) | 467.3 | 391.3 |
| Skeletal density (g/cm³) | 2.16 | 1.85 |
| Porosity (%) | 83.4 | 72 |

In some examples, the average thickness of the material is substantially the same before and after the coating is applied. In some examples, the density of the material after the coating may increase from about 35% to 40%, 40% to 45%, 45% to 50%, or any other suitable combination of ranges or value therebetween, as compared to the density before coating. In some examples, the Gurley measurement of the material after the coating may decrease from about 10% to 15%, 15% to 20%, 25% to 30%, or any other suitable combination of ranges or value therebetween, as compared to the Gurley measurement before coating. In some examples, the skeletal density of the material after the coating may decrease from about 5% to 10%, 10% to 15%, 15% to 20%, or any other suitable combination of ranges or value therebetween, as compared to the skeletal density before coating. In some examples, the porosity of the material after the coating may decrease from about 5% to 10%, 10% to 15%, 15% to 20%, or any other suitable combination of ranges or value therebetween, as compared to the skeletal density before coating.

The disclosure of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this disclosure provided they come within the scope of the appended claims and their equivalents.

### LIST OF REFERENCE SIGNS

1 inlet gas stream, gas inflow, main gas inflow direction
2 outlet gas stream, gas outflow, main gas outflow direction
3 gas inlet channel
4 gas outlet channel
5 particulate sorbent material layer element
6 sheet of fabric material enclosing the sorbent material
7 part of a frame, defining the geometrical structure of a sorbent layer and supporting the fabric material enclosing the sorbent material
8 legs of 7 parallel to inlet face 18
9 sheet of metal, heat exchange lamella
10 holes in 9 for 11
11 tube containing/guiding a heat transfer fluid
12 inner wire grid layer
13 outer wire grid layer
14 slat for attaching the layers
15 frame rivet
16 wide slat, tongue
17 sealing protrusion on 16
18 inlet face
19 outlet face
20 groove for receiving 16
21 frame structure of heat exchange element
22 heat exchange element
23 U turn of 11
24 center rivet
25 rivet tube of 24
26 rivet pin of 24
27 head of 25
28 head of 26
29 inlet/outlet tubing for heat exchange element
30 support element
31 round nose portion of 30
32 outer leg portion of 30
33 inner leg portion of 30
34 inflow duct
35 widening wall portion of 34
36 turbulence reducer at 35
37 main horizontal axis of the whole unit
38 filter fabric material
39 upstream nose profile
40 round nose portion of 39
41 outer leg portion of 39
42 central leg portion of 39
43 insertion slots of layers 5
44 recessed portion of 41
45 outer cut-out
46 inner cut-out
47 fastening elements of 39
48 39 without rounded nose portion
50 downstream edge of 36
51 radial portion of 36
52 closed blind rivet nut in frame 7″ for fastening on side wall
53 closed blind rivet nut in frame element 7″ in holes for filling with sorbent
54 side wall of stack (right side)
55 rivet nut in wall 54
56 bores in side wall for 55 for fastening of frames on side wall
57 lines to indicate the mounting scheme of the frames on the side wall
58 cut-out for top cover plate
59 bent-over edge on lateral side
60 bent-over edge on bottom side
61 U-Profile on 54
62 wedges on 54
63 insertion groove for 5
64 drawer tongue
65 extra rivets in border regions
66 drawer groove
67 covering plate
68 separation wall
100 main inflow
101 inflow into stack at central portions
102 inflow into stack at outer portions
1800 particulate active material construct
1802 sheets of flexible fabric material, or faces thereof
1803 cavity
1804 loose particulate active material
1806 tubes
1808 channels
1810 connection members
1812 airflow channels
1900 flow of desorbing media
1902 flow of carbon dioxide
1904 flow of cooling liquid
1906 flow of heat from sorbent material
1908 flow of pressurizing fluid
1910 flow of internal pressure
2100 conductors
2200 gas separation unit
2201 spaces
2202 manifolds for desorbing media flow
2204 manifold for carbon dioxide collection
2206 external frame
2208 ports
2500 integral resealable feature
2502 control mechanism for 2500
2504 access opening
2506 frame structure or legs thereof
2508 holes for penetration by 1806
2800 inactive carrier particle
2802 pores of 2800
2804 hydrophobic coating
2900 strand-like structures
2902 oblong pill-shaped structures
2904 irregularly shaped structures
A 39 without rounded nose portion
B-D 39 with successively increasing length nose portions
a center frame stacking distance at the opening edge
b middle frame stacking distance at the opening edge
c outer frame stacking distance at the opening edge
d distance between 9
D depth of 1800 or 2200
Do outer diameter of 9
Di inner diameter of 9
Dft total frame depth
Df frame depth
G gap between adjacent 1800
h height of 9
H height of 2200I_{B-D} lengths of B-D, respectively
t thickness of 1802
T thickness of 1800
w width of 9
W width of 1800 or 2200
Wf frame width
V′ rivet spacing of second group of rivets in transverse direction
V″ rivet spacing of second group of rivets in longitudinal direction
y′ rivet spacing in transverse direction
y″ rivet spacing in longitudinal direction
X distance between adjacent 9
Z protrusion length of 23

What is claimed is:

1. A gas separation unit for the separation of at least a first gas from a mixture containing said first gas as well as further gases different from the first gas by a cyclic adsorption/desorption process, the gas separation unit comprising:
a plurality of particulate active material constructs arranged in at least two stacked layers,
wherein each layer of the particulate active material construct comprises two sheets of a flexible fabric material which is hydrophobic and gas permeable but impermeable to a loose particulate active material for gas adsorption,
wherein the sheets are:
arranged essentially parallel defining an inlet face of the layer and an outlet face of the layer,
arranged and separated with a distance between the sheets in the range of inclusively between 1-5 mm,
enclosing a cavity in which the loose particulate active material is located, and
mounted on a manifold frame structure,
wherein said frame structure is formed by four metal profiles arranged pairwise mutually parallel, said metal profiles having pairs of legs that are arranged essentially parallel to said inlet face of the layer and said outlet face of the layer, respectively, and allow for fixing said sheets circumferentially to said legs on each respective face,
wherein a plurality of tubes for a heat exchange fluid is provided within said frame structure and within said cavity,
wherein the plurality of tubes, at least over non-bent portions thereof, are arranged essentially parallel to one first pair of said mutually parallel metal profiles and are in thermal contact with a plurality of sheets of metal,
wherein the sheets of metal are arranged essentially perpendicular to a main plane of the frame structure and perpendicular to said tubes, and extend in a continuous manner between said first pair of mutually parallel metal profiles and are provided with a plurality of holes through which the plurality of tubes penetrate,
wherein the unit has a desorbing media inlet side or desorbing media inlet manifold through which the desorbing media enters the unit and a desorbing media outlet side or desorbing media outlet manifold through which the desorbing media exits the unit, a desorbing media pathway between the inflow and the outflow being confined in the unit to pass through at least one layer,
wherein said layers are arranged in the unit such that a gas inflow into the unit passes through the inlet face, subsequently through the loose particulate active material located in the cavity of the respective layer, and subsequently to exit the respective layer through the outlet face to form a gas outflow leaving the unit,
wherein the layers are arranged such that inlet faces of adjacent layers are facing each other and enclose gas inlet channels, and such that outlet faces are facing each other and enclose gas outlet channels,
wherein a mean distance between inlet faces and/or outlet faces defining said channels, measured in a direction essentially perpendicular to a main gas inflow direction and a main gas outflow direction, respectively, is in the range of inclusively between 0.1-15 cm,
wherein the total frame depth is in the range of inclusively between 0.5-1.8 m and the frame width is in the range of inclusively between 0.5-1.9 m, and
wherein the layers of the stack of at least two layers are held in place in a housing by at least a pair of side walls which are either arranged pairwise vertically or pairwise horizontally, and on which side walls elements are provided, which allow individual layers to be shifted into the housing in a replaceable manner.

2. The gas separation unit according to claim 1, wherein the distance between the sheets is in the range of inclusively between 1-3 mm.

3. The gas separation unit according to claim 1, wherein the mean distance defining said channels is in the range of inclusively between 1-5 mm.

4. The gas separation unit according to claim 1, wherein the sheets of the flexible fabric material each have a sufficiently small porosity to prevent the loose particulate active material from passing therethrough while facilitating passage of air and carbon dioxide therethrough.

5. The gas separation unit according to claim 1, wherein the loose particulate active material comprises a plurality of loose active particles, wherein each of the loose active particles has a cross-sectional width or height in the range of inclusively between 2-1200 μm.

6. The gas separation unit according to claim 1, further comprising a plurality of connectors disposed between adjacent tubes.

7. The gas separation unit according to claim 6, wherein the connectors are configured to maintain the tubes in a parallel configuration with respect to each other.

8. The gas separation unit according to claim 6, wherein the connectors are configured to extend at least partially along a length of the tubes.

9. The gas separation unit according to claim 6, wherein the connectors are selectively permeable barriers configured to allow airflow therethrough while preventing the loose particulate active material from passing therethrough.

10. The gas separation unit according to claim 1, wherein each of the plurality of particulate active material constructs includes an integral resealable feature that is configured to provide an access opening for the cavity such that the loose particulate active material can be filled inside the cavity or removed from the cavity.

11. The gas separation unit according to claim 10, wherein the integral resealable feature includes one or more fasteners implemented on the inlet face or the outlet face of the layer.

12. The gas separation unit according to claim 1, wherein at least one of the plurality of tubes includes a conductor component extending at least partially therethrough, wherein the conductor component is configured to perform electrical resistance heating to facilitate the cyclic adsorption/desorption process.

13. The gas separation unit according to claim 12, wherein the conductor component comprises a conductor material having an electrical resistivity of inclusively between 1.00×10⁻⁶ Ωm and 2.00×10⁻⁶ Ωm at room temperature (20° C.).

14. The gas separation unit according to claim 1, wherein the loose particulate active material is formed by coating a loose particulate inactive material with a hydrophobic coating such that a second surface area of the loose particulate inactive material with the coating is at least 80% of a first surface area of the loose particulate inactive material without the coating.

15. The gas separation unit according to claim 1, wherein the loose particulate active material is formed by coating a loose particulate inactive material with a hydrophobic coating such that a second porosity/permeability of the loose particulate inactive material with the coating is at least 80% of a first porosity/permeability of the loose particulate inactive material without the coating.

16. The gas separation unit according to claim 1, wherein the flexible fabric material is fixed to the frame structure by means of slats, and wherein the flexible fabric material is sandwiched between the respective slat and the leg of the metal profile.

17. The gas separation unit according to claim 1, wherein the elements on the side walls are provided as at least one of: U-shaped profiles attached to the side wall;
wedges attached to the side wall; groove elements attached to the side wall cooperating with tongue elements attached to the layer or to the lateral frame of the layer.

18. The gas separation unit according to claim 1, wherein pairs of adjacent frame structures are provided, at the facing edges contacting in use with in one case a tongue protrusion extending over the full width of the edge, and a corresponding counter profile providing a slot also extending over the full width of the edge, such that by inserting said tongue of one frame into said slot of the adjacent frame the adjacent frame elements are mechanically fixed as well as sealed relative to each other.

19. The gas separation unit according to claim 1, wherein the total frame depth is in the range of 0.75-1.25 m or 0.9-1.1 m and/or the frame width is in the range of 0.5-1.9 m or of 1.1-1.7 m.

20. The gas separation unit according to claim 1, wherein the tubes are metal tubes, including aluminum or copper tubes.

21. The gas separation unit according to claim 1, wherein the tubes where running parallel are spaced by a distance in the range of 10-168 mm.

22. The gas separation unit according to claim 1,
wherein the sheets of metal have a thickness in the range of 0.1-0.4 mm, or
wherein the sheets of metal have a height, measured perpendicular to the running direction of the tubes in the range of 3-50 mm.

23. The gas separation unit according to claim 1,
wherein the sheets of metal have a length being less than 20 mm shorter than the distance between the respective pair of metal profiles arranged pairwise mutually parallel forming said frame structure, or
wherein the sheets of metal are made of aluminum, or wherein the sheets of metal are spaced by a distance in the range of 1-15 mm.

24. The gas separation unit according to claim 1,
wherein the flexible fabric material is woven or nonwoven textile material, or
wherein the flexible fabric material has a thickness in the range of 0.1-4 mm, or
wherein the flexible fabric material, has a gas, or an air permeability in the range of 2500-5000 L/m²/s, or
wherein at least the upstream layer of the flexible fabric material is chosen as a filter fabric material of at least M6 or at least F6 or at least F7 class according to DIN EN 779, or
wherein additional to the upstream layer of the flexible fabric material there is provided filter fabric material of at least M6 or at least F6 or at least F7 class.

25. The gas separation unit according to claim 1, wherein within the frame structure there is provided a plurality of attachment elements, for holding at least said flexible fabric material layers together.

26. The gas separation unit according to claim 1, wherein the layers are arranged so that in one stack in a direction transverse to the inflow of air at one height at least two layers are arranged next to each other.

27. The gas separation unit according to claim 1, wherein the unit is configured to extract carbon dioxide from at least one of air or flue gases or biogas or other CO₂-containing gas streams.

28. The gas separation unit according to claim 1,
wherein the flexible fabric material is fixed to the frame structure by means of metal slats, extending essentially over the full-length of the respective metal profile, and
wherein the flexible fabric material and is sandwiched between the respective slat and the leg of the metal profile, and
wherein the slat is fixed to the respective leg by at least one, or a row of rivet joint connections.

29. The gas separation unit according to claim 1,
wherein pairs of adjacent frame structures are provided, at the facing edges contacting in use with in one case a tongue protrusion extending over the full width of the edge, and a corresponding counter profile providing a slot also extending over the full width of the edge, such that by inserting said tongue of one frame into said slot of the adjacent frame the adjacent frame elements are mechanically fixed as well as sealed relative to each other,
wherein said tongue protrusion is realized by means of a correspondingly structured wide slat at the same time used for fixing the flexible fabric material and, if present, additional grid structures to the leg of the corresponding metal profile, and/or
wherein said counter profile also comprises a slat which at the same time can be used for fixing the flexible fabric material to the leg of the corresponding metal profile of the adjacent frame.

30. The gas separation unit according to claim 1, wherein the tubes are aluminum or copper tubes, with an inner diameter in the range of 3-20 mm, or in the range of 5-12 mm, and with an outer diameter in the range of 4-24 mm, or in the range of 6.2-14 mm.

31. The gas separation unit according to claim 1, wherein the tubes where running parallel are spaced by a distance in the range of 15.5-98 mm.

32. The gas separation unit according to claim 1,
wherein the sheets of metal have a thickness in the range of 0.12-0.18 mm, or
wherein the sheets of metal have a height, measured perpendicular to the running direction of the tubes in the range of 8-22 mm.

33. The gas separation unit according to claim 1,
wherein the sheets of metal have a length being less than 5 mm shorter than the distance between the respective pair of metal profiles arranged pairwise mutually parallel forming said frame structure, or
wherein the sheets of metal are spaced by a distance in the range of 3.5-7 mm or 4-5.5 mm.

34. The gas separation unit according to claim 1, wherein the flexible fabric material is woven or nonwoven textile material based on metallic and/or fibers or yarns, respectively, or
wherein the flexible fabric material has a thickness in the range of 0.15-1 mm, or
wherein the flexible fabric material, has a gas, or an air permeability in the range of 3000-4000 L/m²/s.

35. The gas separation unit according to claim 1, wherein within the frame structure and across the heat exchange element as well as the layers of flexible fabric material, there is provided a plurality of attachment elements, said attachment elements being:
in the form of glue or weldings or soldering or center rivet connections, or
in the form of transverse or longitudinal slats affixed with at least one of these, for holding at least said flexible fabric material layers together.

36. The gas separation unit according to claim 1, wherein the layers are arranged vertically so that between the layers there are vertical slots, and wherein at the upper edges of the layers at least at the upstream side of the respective layer there is provided at least one horizontal covering plate covering the uppermost portion of the flexible fabric layer.

37. The gas separation unit according to claim 1, wherein the layers are arranged so that in one stack in a direction transverse to the inflow of air at one height at least two layers are arranged next to each other, held in place by way of the sidewalls and/or a vertical separation wall between the transversely adjacent layers.

38. The gas separation unit according to claim 1, wherein the layers of the stack of at least two layers are held in place or together in the housing by at least a pair of side walls which are either arranged pairwise vertically or pairwise horizontally, and on which side walls the lateral metal profiles are fixed, wherein the side walls are provided with a pattern of fixing elements to allow for fixing the lateral metal profiles on the respective side wall, wherein the fixing elements are structured as holes, grooves, ribs, and/or studs.

39. A gas separation unit for the separation of at least a first gas from a gas mixture containing said first gas as well as further gases different from the first gas by a cyclic adsorption/desorption process, the gas separation unit comprising:
a plurality of particulate active material constructs arranged in at least two stacked layers,
wherein each layer of the particulate active material construct comprises two sheets of a flexible fabric material which is hydrophobic and gas permeable but impermeable to a loose particulate active material for gas adsorption,
wherein the sheets are:
arranged essentially parallel defining an inlet face of the layer and an outlet face of the layer,
arranged and separated with a distance between the sheets in the range of inclusively between 1-5 mm,
enclose a cavity in which the loose particulate active material is located, and
mounted on a stiff rectangular circumferential frame structure,
wherein said stiff rectangular circumferential frame structure is formed by four metal profiles arranged pairwise mutually parallel,
wherein said metal profiles have pairs of legs arranged essentially parallel to said inlet face of the layer and said outlet face of the layer, respectively, and allow for fixing said sheets circumferentially to said legs on each respective face,
wherein a plurality of tubes for a heat exchange fluid is provided within said stiff rectangular circumferential frame structure and within said cavity,
wherein the plurality of tubes, at least over non-bent portions thereof, are arranged essentially parallel to one first pair of said mutually parallel metal profiles and are in thermal contact with a plurality of sheets of metal,
wherein the sheets are arranged essentially perpendicular to a main plane of the frame structure and perpendicular to said tubes and extend in a continuous manner between said first pair of mutually parallel metal profiles and are provided with a plurality of holes through which the plurality of tubes penetrate,
wherein the unit has a desorbing media inlet side or desorbing media inlet manifold through which the desorbing media enters the unit and a desorbing media outlet side or desorbing media outlet manifold through which the desorbing media exits the unit, a desorbing media pathway between the inflow and the outflow being confined in the unit to pass through at least one layer,
wherein said layers are arranged in the unit such that a gas inflow into the unit passes through the inlet face, subsequently through the loose particulate active material located in the cavity of the respective layer, and subsequently to exit the respective layer through the outlet face to form a gas outflow leaving the unit,
wherein the layers are arranged such that inlet faces of adjacent layers are facing each other and enclose gas inlet channels, and such that outlet faces are facing each other and enclose gas outlet channels,
wherein a mean distance between inlet faces and/or outlet faces defining said channels, measured in a direction essentially perpendicular to a main gas inflow direction and a main gas outflow direction, respectively, is in the range of inclusively between 0.1-15 cm,
wherein a total frame depth is in a range of inclusively between 0.5-1.8 m and the frame's width is in a range of inclusively between 0.5-1.9 m, and
wherein the layers are arranged vertically so that between the layers there are vertical slots.

40. The gas separation unit according to claim 39, wherein the layers of the stack of at least two layers are held in place or together in a housing by at least a pair of side walls which are either arranged pairwise vertically or pairwise horizontally, and on which side walls a lateral metal profiles are fixed.

41. A gas separation unit for the separation of at least a first gas from a mixture containing said first gas as well as further gases different from the first gas by a cyclic adsorption/desorption process, the gas separation unit comprising:
a plurality of particulate active material constructs arranged in at least two stacked layers,
wherein each layer of the particulate active material construct comprises two sheets of a flexible fabric material which is hydrophobic and gas permeable but impermeable to a loose particulate active material for gas adsorption,
wherein the sheets are:
arranged essentially parallel defining an inlet face of the layer and an outlet face of the layer,
arranged and separated with a distance between the sheets in the range of inclusively between 1-5 mm,
enclosing a cavity in which the loose particulate active material is located, and
mounted on a stiff rectangular circumferential frame structure,
wherein a plurality of tubes for a heat exchange fluid is provided within said frame structure and within said cavity,
wherein the plurality of tubes, at least over non-bent portions thereof, are arranged essentially parallel to each other via a plurality of connection members,
wherein the frame structure is provided with a plurality of holes through which the plurality of tubes penetrate,
wherein the unit has a desorbing media inlet side or desorbing media inlet manifold through which the desorbing media enters the unit and a desorbing media outlet side or desorbing media outlet manifold through which the desorbing media exits the unit, a desorbing media pathway between the inflow and the outflow being confined in the unit to pass through at least one layer,
wherein said layers are arranged in the unit such that a gas inflow into the unit passes through the inlet face, subsequently through the loose particulate active material located in the cavity of the respective layer, and subsequently to exit the respective layer through the outlet face to form a gas outflow leaving the unit,
wherein the layers are arranged such that inlet faces of adjacent layers are facing each other and enclose gas inlet channels, and such that outlet faces are facing each other and enclose gas outlet channels,
wherein a mean distance between inlet faces and/or outlet faces defining said channels, measured in a direction essentially perpendicular to a main gas inflow direction and a main gas outflow direction, respectively, is in the range of inclusively between 0.1-15 cm,
wherein the total frame depth is in the range of inclusively between 0.5-1.8 m and the frame width is in the range of inclusively between 0.5-1.9 m, and
wherein the layers of the stack of at least two layers are slidably and removably held in place in a housing.
